(19) United States
(12) Patent Application Publication
(10) Pub. No.: US 2013/0110950 A1
(43) Pub. Date: May 2, 2013

(54) METHOD AND SYSTEM FOR DYNAMIC CONTENT DELIVERY USING MULTIPLE TEMPLATES

(71) Applicant: Adknowledge, Inc., Kansas City, MO (US)

(72) Inventors: Lawrence Paul MARTINE, Los Angeles, CA (US); Jeremy Matthew HOGGATT, Lee's Summit, MO (US); Nicholas DELORME, Peculiar, MO (US)

(73) Assignee: Adknowledge, Inc., Kansas City, MO (US)

(21) Appl. No.: 13/716,466

(22) Filed: Dec. 17, 2012

Related U.S. Application Data
(63) Continuation-in-part of application No. 11/774,106, filed on Jul. 6, 2007.
(60) Provisional application No. 61/630,670, filed on Dec. 17, 2011.

(51) Int. Cl. H04L 12/58

(52) U.S. Cl. CPC H04L 51/00
USPC 709/206

(57) ABSTRACT

Disclosed are methods and systems for providing content for electronic communications, which are typically sent by a separate sender entity. The system provides suggested templates for supporting content supporting graphics, also known as creatives, to the sender entity. The sender entity packages the suggested template and creative into an electronic communication and sends it to the intended recipient.

### CROSS-REFERENCES TO RELATED APPLICATIONS

This patent application is related to and claims priority from commonly owned U.S. Provisional Patent Application Ser. No. 61/630,670, entitled: Method and System for Dynamic Content Delivery Using Multiple Templates, filed on Dec. 17, 2011, the disclosure of which is incorporated by reference in its entirety herein. This patent application is also a continuation in part application of commonly owned U.S. patent application Ser. No. 11/774,106, entitled: Method and System for Providing Electronic Communications With Dynamically Provided Content To Third Party Mail Transfer Agents, filed on Jul. 6, 2007, published as Patent Application Publication No. US 2008/0098075 A1. U.S. Provisional Patent Application Ser. No. 61/630,670 is related to commonly owned U.S. patent application Ser. No. 11/774,106, entitled: Method and System for Providing Electronic Communications With Dynamically Provided Content To Third Party Mail Transfer Agents, filed on Jul. 6, 2007, published as Patent Application Publication No. US 2008/0098075 A1. The disclosure of U.S. patent application Ser. No. 11/774,106, entitled: Method and System for Providing Electronic Communications With Dynamically Provided Content To Third Party Mail Transfer Agents, filed on Jul. 6, 2007, published as Patent Application Publication No. US 2008/0098075 A1, is incorporated by reference in its entirety herein.

### TECHNICAL FIELD

The present disclosed subject matter relates to content delivery over networks and components associated therewith.

### BACKGROUND

Electronic communications have dramatically changed the ways in which people communicate. Electronic mail, commonly referred to as e-mail, is a widely used form of electronic communication. E-mail is the exchange of computer-stored messages by telecommunication, over a network, such as the Internet. E-mail accounts for the largest percentage of total traffic on the Internet. E-mail usage is expected to increase exponentially in the next few years as increasing numbers of people have access to computers, and therefore, the World Wide Web (WWW).

E-mail communications are desirable, as they are current, usually in real time, and are non-intrusive. Conversely, a telephone call is intrusive, as it must be attended to at the moment it is received, and may interfere with the recipient's activities. The e-mail recipient may open the e-mail when desired, and may delete the e-mail without reading it.

E-mail distribution to individuals and organizations is quick and economical. Senders create recipient lists, that may include thousands of recipients. Recipient e-mail addresses can be added and deleted from the lists as desired. The e-mail is composed once and sent to multitudes of recipients, all of whom receive the e-mail instantaneously. The e-mail can be duplicated and sent to recipients from another recipient list, typically in a matter of minutes.

Electronic mail is becoming ever popular for advertising. Business is allocating more of their advertising budgets to electronic media, such as networks, including the Internet. The advertisements are typically carried in electronic communications, and typically e-mail. For example, one type of e-mail suitable for advertising is disclosed in commonly owned U.S. Patent Application Publication No. 2005/0038861 A1 (Published U.S. patent application Ser. No. 10/915,975, filed Aug. 11, 2004), entitled: Method And System For Dynamically Generating Electronic Communications, this document, and the disclosure of which, is incorporated by reference herein. This document discloses, for example, providing content to e-mail, used for advertising, product promotion and the like, when the e-mail is opened.

Contemporary e-mail advertising is typically in batch e-mails. Sending batches of e-mails is an all or nothing proposition, as not all recipients will be interested in the advertisement. As a result, only certain recipients of the e-mail will remain captive customers. The other e-mails, that were not opened or not responded to due to lack of interest in the subject matter are considered wasted. E-mail recipients may be targeted, so that batch e-mail may be sent, but again, such a batch e-mail, will not be interesting to all recipients, whereby a portion of the e-mails of the batch e-mail are wasted.

### SUMMARY OF THE DISCLOSED SUBJECT MATTER

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display, for example, an activatable link, that causes an action of the various software and or hardware supporting the computer screen display.

A banner is a graphic that appears on the monitor of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as they are placed into the creative, at the time the creative is activated, which may be upon the opening of an electronic communication, or e-mail, with the creative, for example, as disclosed in U.S. patent application Ser. No. 11/774,106. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipients browsing application or browser to be directed to the target web site corresponding to the activated link.

Pay Per Click (PPC), also known as price per click and cost per click, as used herein, is the amount of money that an advertiser, web site promoter, or other party who owns or is associated with a web site, will pay to a system administrator for providing their advertisement, listing, link or the like to a user, and the user clicks their mouse or pointing device on the advertisement, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence of servers, databases, caches, components, listings, links, data files, etc.

“Click through” or “click throughs” are industry standard terms for a user clicking on a link in an electronic object, such as an e-mail, banner, listing on a web site, for example, a web site of a search engine, or the like, and ultimately having their browser directed to the targeted data object, typically a web site, associated with the link.

The present disclosed subject matter improves on the contemporary art in that it provides individualized communications to each user, based on data corresponding to each user. For example, the present disclosed subject matter provides individualized advertising communications, such as in the form of electronic mail (e-mail), for each specific user, based on data corresponding to that particular user. Moreover, the electronic mail, is provided by a provider, who also provides the content, but does not send the e-mail to the user. Rather, the sender of the e-mail may be third party sender, and the e-mail is electronically linked content provider, who provides the content to the e-mail, for example, once the e-mail is opened. Alternately, the content of the e-mail can be provided with static or fixed content. The specific e-mail for each intended recipient is selected by processes detailed herein.

The disclosed subject matter is directed to systems and methods for providing individualized communications to each user, based on data corresponding to each individual user, for placement into electronic communications by a sending party, that may not be related to the party providing the content. The content provided to the electronic communications may be generated at least in part when the communication is opened by the intended recipient (the individual user). The content may be the body of an electronic mail as well as, for example, a tag line or footer in an electronic mail.

By providing to the sending party the content of the e-mail, and the third party sending the e-mail, for example, an advertising e-mail, sending individualized e-mails, for specific advertising campaigns is highly efficient. This is because the proper recipients (users) are targeted, with a high percentage chance that these recipients will respond to the e-mail and remain a captive customer of the target web site or other web site linked thereto.

The disclosed subject matter is directed to a method for providing content to an electronic communication. The method includes receiving an identifier, for example, a unique identifier, corresponding to the intended recipient of an electronic communication, and obtaining data for the content of the electronic communication based on the received identifier. Data is then provided for the content of the electronic communication to the entity associated with sending the electronic communication to the intended recipient, for placement into the electronic communication. The electronic communication may be, for example, electronic mail (e-mail).

The disclosed subject matter is also directed to another method for providing content to an electronic communication. This method includes receiving an identifier, for example, a unique identifier, corresponding to the intended recipient of an electronic communication, obtaining data for the content of the electronic communication based on the received identifier, and, providing the data for the content of the electronic communication to the entity associated with sending the electronic communication to the intended recipient. This data is for placement into the electronic communication, and includes at least one image link, for obtaining the body of the opened electronic communication, and at least one click link, for providing activatable links for the body, the activatable links, for example, associated with uniform resource locators (URLs), such as those for target web sites. The activatable links, for example, may be obtained dynamically, when the electronic communication is opened or otherwise activated.

The disclosed subject matter is also directed to another method for providing content to an electronic communication. The method includes receiving an identifier, for example, a unique identifier, corresponding to the intended recipient of an electronic communication, obtaining data for the content of the electronic communication based on the received identifier, and, providing the data for the content of the electronic communication to the entity associated with sending the electronic communication to the intended recipient, for placement into the electronic communication as a text box. The data includes at least one click link. The click link, for example, provides an activatable link, that is associated with a uniform resource locators (URL), such as that for a target web site. For example, the actual URL(s) is/are obtained when the requisite portion of the text box is activated or clicked.

The disclosed subject matter is directed to a system for providing content to electronic communications. The system includes multiple components. A first component is for receiving an identifier, for example, a unique identifier, corresponding to the intended recipient of an electronic communication. A second component is for obtaining data for the content of the electronic communication based on the received identifier. A third component is for providing the data for the content of the electronic communication to the entity associated with sending the electronic communication to the intended recipient, for placement into the electronic communication. A fourth component is for receiving the data the content of the electronic communication and providing the content to electronic communication once it has been opened by the intended recipient.

The disclosed subject matter is also directed to a system for providing content to electronic communications. The system includes a first component for receiving an identifier, for example, a unique identifier, corresponding to the intended recipient of an electronic communication and a second component for obtaining content data for the content of the electronic communication based on the received identifier, the content data including data for an activatable link. There is also a third component for providing the content data for the content of the electronic communication to the entity associated with sending the electronic communication to the intended recipient, for placement into the electronic communication. There is a fourth component for receiving data that the activatable link was activated and obtaining the uniform resource locator of a target web site when the activatable link is activated.

The disclosed subject matter is also directed to a system and method where creatives and templates are provided to the publisher, for use in the electronic communications sent by the publisher to the recipients, which when activated by the recipients provide the content to the recipients, are provided from, for example, an e-mail Application Programming Interface (API) server of a computer system, also known as a “central system,” of an entity. The creatives provided are for use with a series of templates. The templates of the series include a master and variations, including reformations, of the master template. The API server or the publishers can select the template or variation thereof, which will support the various images, and/or images, sub images, and hot spots, which, when rendered over the template, form the creative. The recipients will initially receive the computer system recommended template or the publisher-selected template, followed by the automatic rendering of the images, and/or images, sub images, and hot spots over the template, when the electronic communication, for example, the e-mail, is opened by the recipient.

The disclosed subject matter is also directed to a computer-implemented method for providing content to an electronic communication over a communications network. The method comprises the performance of processes by a computer system which include: a) receiving an identifier, for example, an encrypted identifier, the identifier corresponding to an e-mail address of an intended recipient of an electronic communication; b) assigning a classification to the identifier, each time an identifier is received; c) obtaining i) data for a content-supporting graphic (for example, a creative), ii) template data for at least one template for supporting the content-supporting graphic, and iii) data for content requests that automatically activate when the electronic communication is activated, for the electronic communication to be sent by a sender to the intended recipient computer over the communications network, the content-supporting graphic data based on the assigned classification of the received identifier; and, d) providing the data for the content-supporting graphic for the electronic communication, the template data, and the content requests data, to a sender entity, the sender entity for configuring i) the content-supporting data into the at least one template of the template data, and ii) the content requests data, into the electronic communication, and, for sending the electronic communication to the intended recipient computer. The sender entity then sends the electronic communication to the intended recipient computer, over the communications network. The sender entity is, for example, separate from the entity associated with the computer system which provides the data for the electronic communication, which is assembled into the electronic communication by the sender entity, who ultimately sends the electronic communication to the computer of the intended recipient over the communications network.

### BRIEF DESCRIPTION OF DRAWINGS

Attention is now directed to the drawings, where like reference numerals or characters indicate corresponding or like components. In the drawings:

FIG. 1 is a diagram of an exemplary system on which an embodiment of the disclosed subject matter is performed;

FIG. 2 is a flow diagram of a process for generating the content for an e-mail in accordance with an embodiment of the disclosed subject matter;

FIG. 3 is a screen shot showing e-mail communications in the mailbox of a recipient;

FIG. 4 is a screen shot of an exemplary template in accordance with an embodiment of the disclosed subject matter;

FIG. 5 is a flow diagram of the request processing sub process of FIG. 2;

FIG. 6 is a diagram of a key cache in accordance with an embodiment of the disclosed subject matter;

FIG. 7 is a diagram of a listing cache in accordance with an embodiment of the disclosed subject matter;

FIG. 8 is a diagram of a click cache in accordance with the disclosed subject matter;

FIGS. 9A and 9B are a diagram of creatives in accordance with the disclosed subject matter;

FIG. 10 shows screen shot of creatives as they would appear in opened electronic communications in accordance with the disclosed subject matter;

FIG. 11 is a flow diagram of a process for directing an e-mail recipient to a target web site, from a redirect uniform resource locator (URL), upon responding to an e-mail in accordance with the disclosed subject matter;

FIG. 12 is a screen shot showing a web page accessed from a redirect uniform resource locator in accordance with the disclosed subject matter;

FIG. 13 is a diagram of an exemplary templates in accordance with the disclosed subject matter;

FIGS. 14A and 14B are diagrams of the exemplary templates of FIG. 13 in greater detail; and,

FIG. 15 is a diagram of the master template AF of FIG. 13.

### DETAILED DESCRIPTION OF THE DRAWINGS

The present disclosed subject matter is related to systems and methods for providing content to third parties, for example, publishers, for placement into electronic communications by the third party or publisher, for intended recipients of the third parties or publisher. The recipients are typically in a database or list of the publisher. The publisher may not be related to the content provider and the publisher is the sender of the electronic communication with the provided content. The electronic communications that include the provided content are such that portions of the content are time relevant, in that they are generated when the electronic communication is activated, opened, or the like.

The content for the electronic communication, for example, data corresponding to a predetermined image with portions therein for receiving content generated when the electronic communication is opened, is delivered to the intended recipient by the third party or publisher. The time relevant or dynamic content delivered to and placed into designated locations of the image when the electronic communication typically in the form of an electronic mail (e-mail), is opened, for example, in accordance with U.S. patent application Ser. No. 10/915,975, filed Aug. 11, 2004, entitled: Method And System For Dynamically Generating Electronic Communications (U.S. Patent Application Publication No. 2005/0038861 A1), the disclosure of which is incorporated by reference in its entirety herein.

The content, formed, for example, of static and dynamic portions, as well as the e-mails and the data to fill the static content or image, resulting from the opened e-mail, are sent over digital, electronic, wire line or wireless networks, such as the Internet. The time relevant content for the e-mail is dynamic, as it may be generated in real-time, and assembled when the electronic communication, for example, the electronic mail, is opened by the recipient (user). Should the electronic communication be closed and reopened at a subsequent time, it may have dynamic content different from the dynamic content when originally opened, as its content is assembled at the time of reopening, for example, as disclosed in U.S. patent application Ser. No. 10/915,975, filed Aug. 11, 2004 (U.S. Patent Application Publication No. 2005/0038861 A1).

The publishers each receive data for a variety of suggested templates from which they can select one or more of the templates, to send to intended recipients in electronic communications such as e-mail. After the chosen one or more templates is delivered to and activated by the recipient (user), the content is dynamically rendered within the creative supported by the template, when opened by the recipient on the recipient's computer. All template content is custom-designed to populate a corresponding master template, and its variations, including derivative templates and reformed templates (reformations).

Each template can be made into one or more additional variations by the publisher, and may be done so upon a code or recommendation from the Computer (Central) System, e.g., the API Server, or the like. The variation of the template, along with a code for the requisite creative, for the corresponding keyword, campaign, campaign identifier, or the like, is packaged by the publisher into the electronic communication, which is sent to the recipient's computer. When the recipient opens the electronic communication, e.g., the e-mail, the specific template (the master or one of the variations) renders, as does the requisite creative, with hot spots. The hot spots overlie links to content, such as target web sites, the content generated dynamically, and typically automatically, and in real time, when the electronic communication, e.g., e-mail, is opened.

Throughout this document, numerous textual and graphical references are made to trademarks. These trademarks are the property of their respective owners, and are referenced only for explanation purposes herein.

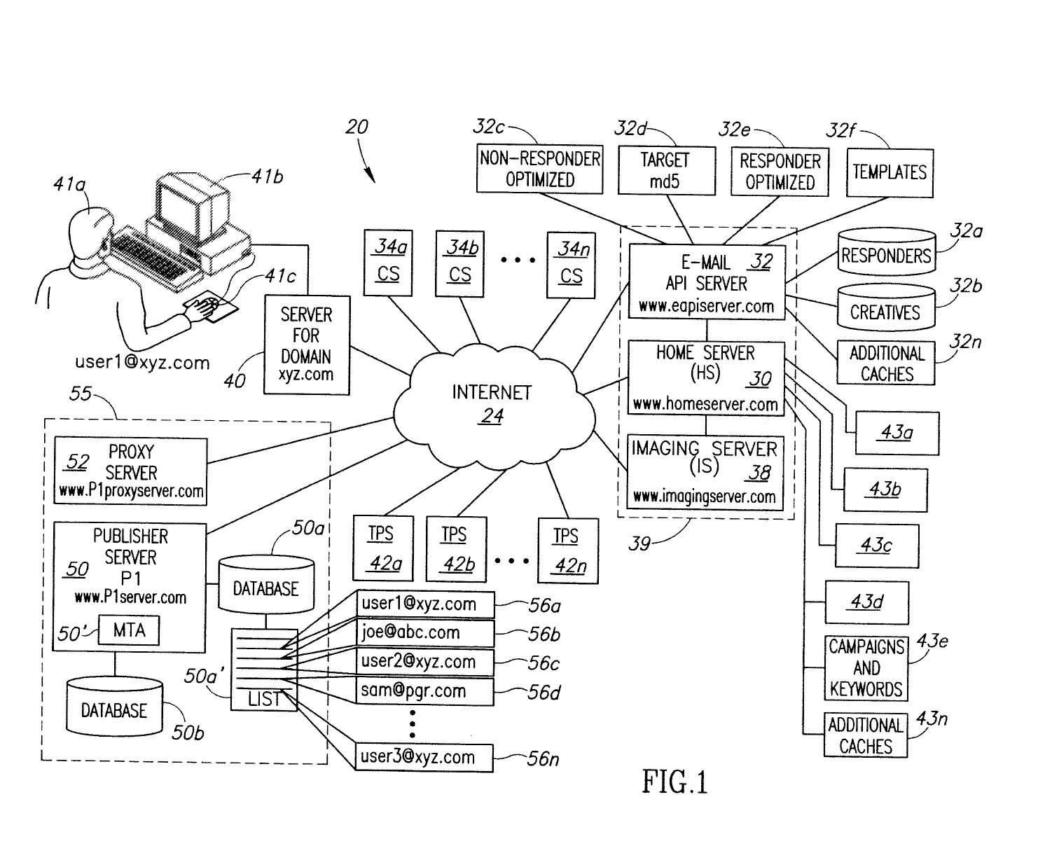

FIG. 1 shows the present disclosed subject matter in an exemplary operation in an exemplary environment. The present disclosed subject matter employs a system 20, formed of various servers and server components, that are linked to a network, communications network, computer network, and the like, such as a wide area network (WAN), that may be, for example, the Internet 24.

There are, for example, numerous servers that form the system 20. These servers, for example, include a home server (HS) 30, an e-mail application program interface (API) server 32, one or more content servers (CS) 34a-34n, and an imaging server (IS) 38. The home server (HS) 30, e-mail API server 32 and imaging server (IS) 38, may be electronically linked internally, and form a computer system, also known as a Central System, which is scalable. The computer system may be controlled by the same entity, who is a content provider, the entity and the computer (central) system, both indicated by the broken line block 39.

These servers 30, 32, 34a-34n and 38 are linked to the Internet 24, so as to be in electronic communication with each other. The servers 30, 32, 34a-34n and 38 include multiple components for performing the requisite functions as detailed below, and the components may be based in hardware, software, or combinations thereof. The servers 30, 32, 34a-34n and 38 may also have internal storage media and/or be associated with external storage media. Servers 30, 32 and 38 are typically coupled in their operation to provide content, for example, as creatives with activatable links (either placed into the creative at a predetermined time or placed into the creative when the supporting electronic communication (for example, when the e-mail is opened), to be utilized by third parties, in providing electronic communications (for example, e-mails), to their intended recipients (users).

A publisher 55 may be, and typically is, separate and unrelated to the entity and the computer system 39, that controls the servers 30, 32, 38. This entity 39 may also be the same entity who provides the text and images with links in the “hot spots” of the creatives. The links, when the intended recipient activates them in the creative, direct the recipient (recipient's browser or browsing application) to a targeted web site. The entity 39 may be one or more entities.

The servers 30, 32, 34a-34n, 38 of the system 20 are linked (either directly or indirectly) to an endless number of other servers and the like, via the Internet 24. Other servers, exemplary for describing the operation of the system 20, include a domain server 40 for the domain (for example, the domain “xyz.com”) of the user 41a (for example, whose e-mail address is user1@xyz.com), linked to the computer 41b of the user 41a. Still other servers may include third party servers (TPS) 42a-42n, controlled by publishers, content providers, web site promoters and other entitles, that may or may not be related to any of the entities detailed above.

The ISP/domain server 40 is linked (either directly or indirectly) to an endless number of other servers and the like, including the servers detailed herein, via the Internet 24. The server 40 includes hardware and software, processors, storage media and the like for performing various server functions including those functions detailed herein. The server 40 handles e-mail and other electronic traffic between the publisher 55 and the intended recipients of the particular domain, e.g., xyz.com.

For example, the intended recipient or user 41a has a computer 41b (such as a multimedia personal computer with a Pentium® CPU, that employs a Windows® operating system), that uses an e-mail client. The computer 41b is linked to the Internet 24. The computer 41b may also be operated by an activatable pointer, such as a mouse 41c or the like. The user 41a may have an e-mail address, for example, of user1@xyz.com.

There is also a server 50, associated with a publisher, server P1, that is, in turn, associated with a proxy server 52. The server 50, known hereinafter as a publisher server (P1) corresponding to a first publisher (P1), and its associated proxy server 52, define an entity known as a publisher, for example, Publisher 1 (P1), as per the broken line box 55. Publisher 1 (P1) 55 is representative of the multiple publishers that may be part of the system 20. The Publisher Server (P1) 50 and the proxy server 52 are typically controlled by the same entity, but may also be controlled by different entities.

While various servers have been listed, this is exemplary only, as the present disclosed subject matter can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the herein mentioned servers, storage media, and components can be linked to each other or to a network, such as the Internet 24, either directly or indirectly.

The home server (HS) 30, also known as the main server, is of an architecture that includes one or more components, modules and the like, for providing numerous additional server functions and operations, for example, comparison and matching functions, policy and/or rules processing, various search and other operational engines, browser directing and redirecting functions, and the like. The home server (HS) 30 includes various processors, including microprocessors, for performing the server functions and operations detailed herein, and storage media, either internal or associated therewith, such as caches 43a-43n. While these caches 43a-43n are shown, this is for explanation purposes, as the home server (HS) 30 may be associated with additional caches, databases, as well as numerous other additional storage media, both internal and external thereto. For explanation purposes, the home server (HS) 30 may have a uniform resource locator (URL) of, for example, www.homeserver.com.

This home server (HS) 30 may employ a search engine, or link to one (in another server or the like via the Internet 24), in order to direct the received request, data, including keywords, key word identifiers, or the like, to the most suitable content server (CS) 34a-34n. While a single home server (HS) 30 is shown, the home server (HS) 30 may be formed of multiple servers and/or components.

The E-mail API (Application Program Interface) server 32 may include one or more components, modules or the like, and may be one or more servers, but is shown for description purposes as a single server. The e-mail API server 32 is of an architecture for receiving md5s (e-mail addresses as hashed by the md5 algorithm, each hashed e-mail address referred to hereinafter as an “md5”), and includes programs for assigning a creative (in code, data or the like, in the cache 32b) to the md5, by any one of numerous methods, and returns, data for the creative, for example, the data including HTML code, as an image request to the publisher server (P1) 50. The e-mail API server 32 also includes data for templates, the data including code for the templates, master and variations, the templates which support creatives. This template data, including code for the requisite template of a template series, is also sent to the publisher server 50 along with the aforementioned data for the creative, which corresponds to the e-mail API server 32 suggested template. The template data, for the master template, variations thereof, and corresponding code and programs for making variations of the master template may be in storage media, e.g., storage media 32f, associated with the e-mail API server 32.

The e-mail API server 32 architecture also supports programs for data generation that is sent to the publisher server (P1) 50, as well as for electronic communication with the home server (HS) 30 and imaging server (IS) 38. The e-mail API server 32 includes various processors, including microprocessors, for performing the aforementioned server functions and operations and storage media, either internal or associated therewith, and caches. A first cache 32a for md5s associated with the cryptographically hashed e-mail addresses received of md5s for recipients (users) who responded to creatives associated with this entity 39. There is a second cache 32b with HTML for the various creatives in the imaging server (IS) 38. A third cache 32c is for target campaigns for non-responder md5s. A fourth cache 32d is for target campaigns for responder md5s, and a fifth cache 32e is for optimized responder campaigns, for the target campaigns for the md5 responders.

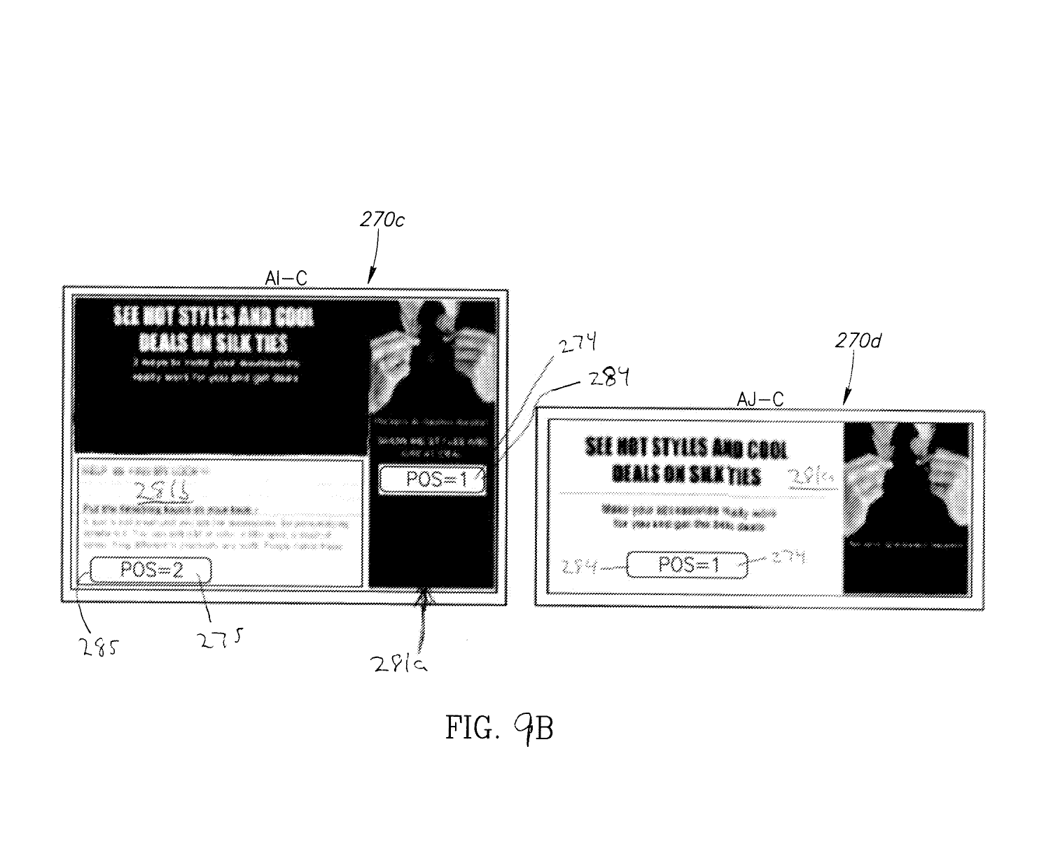

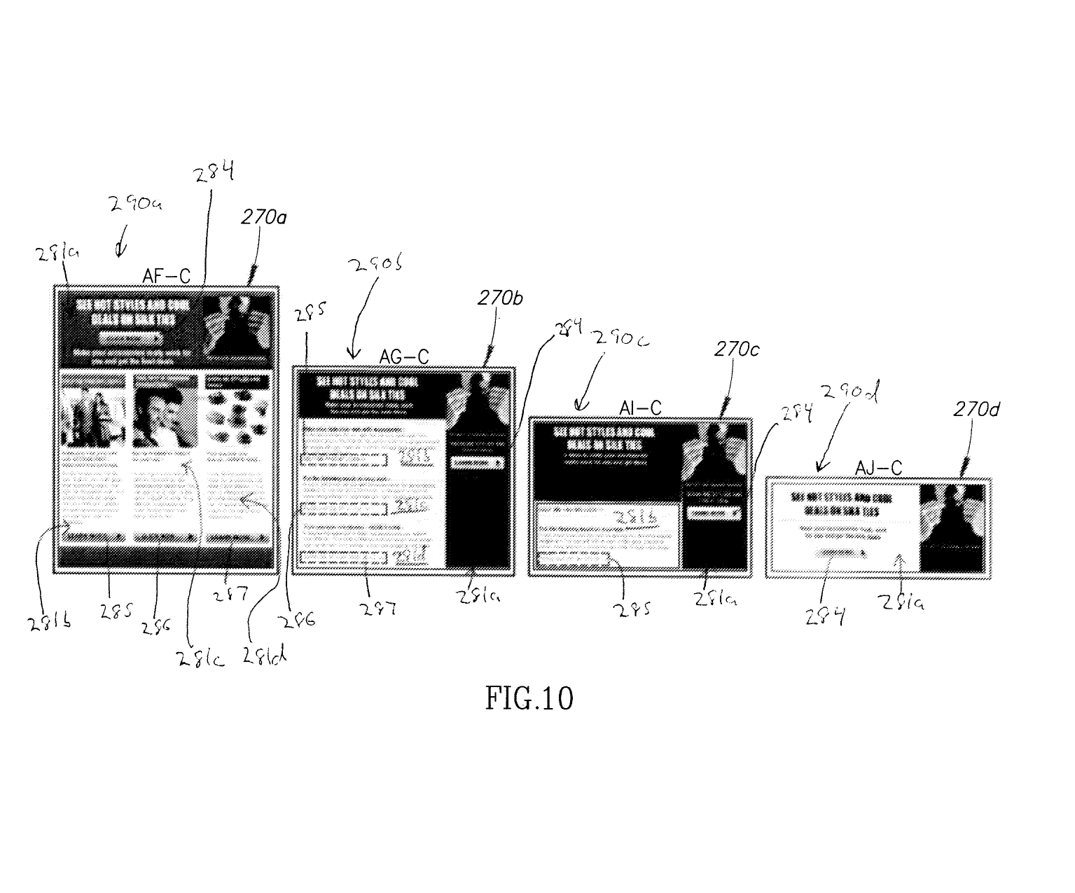

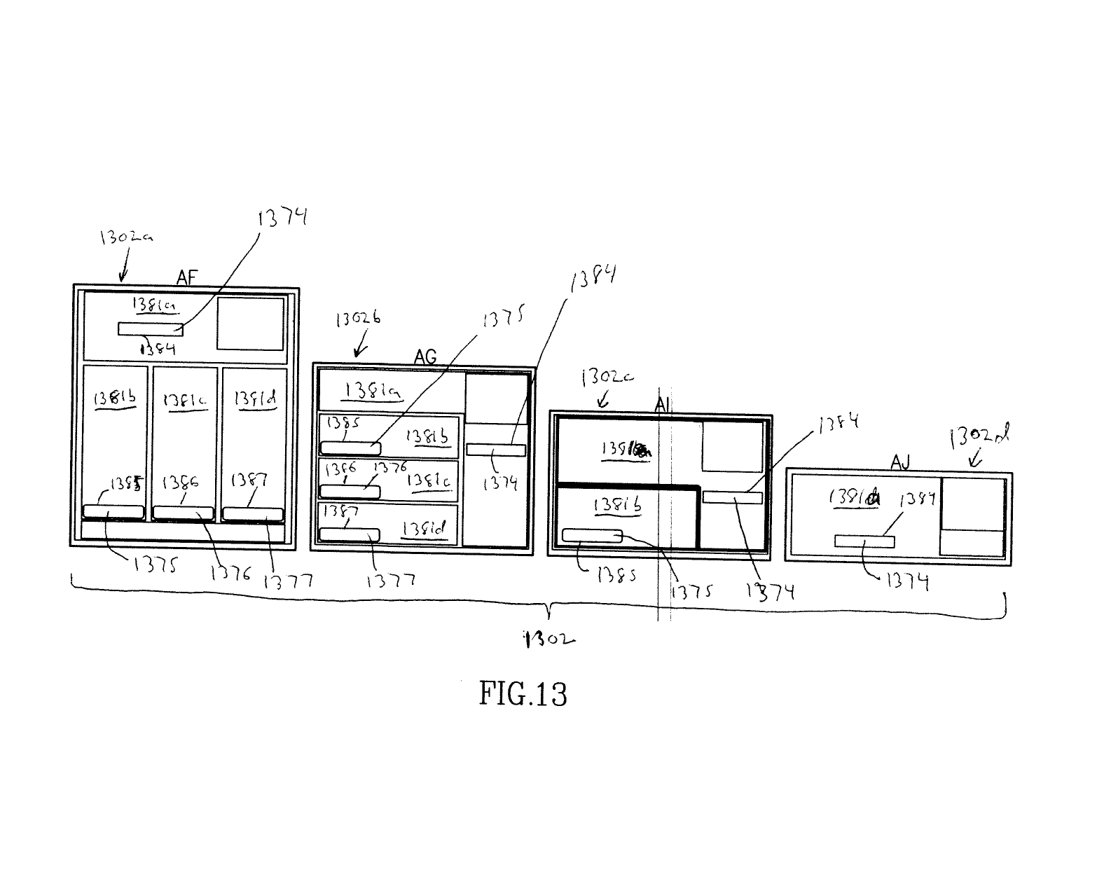

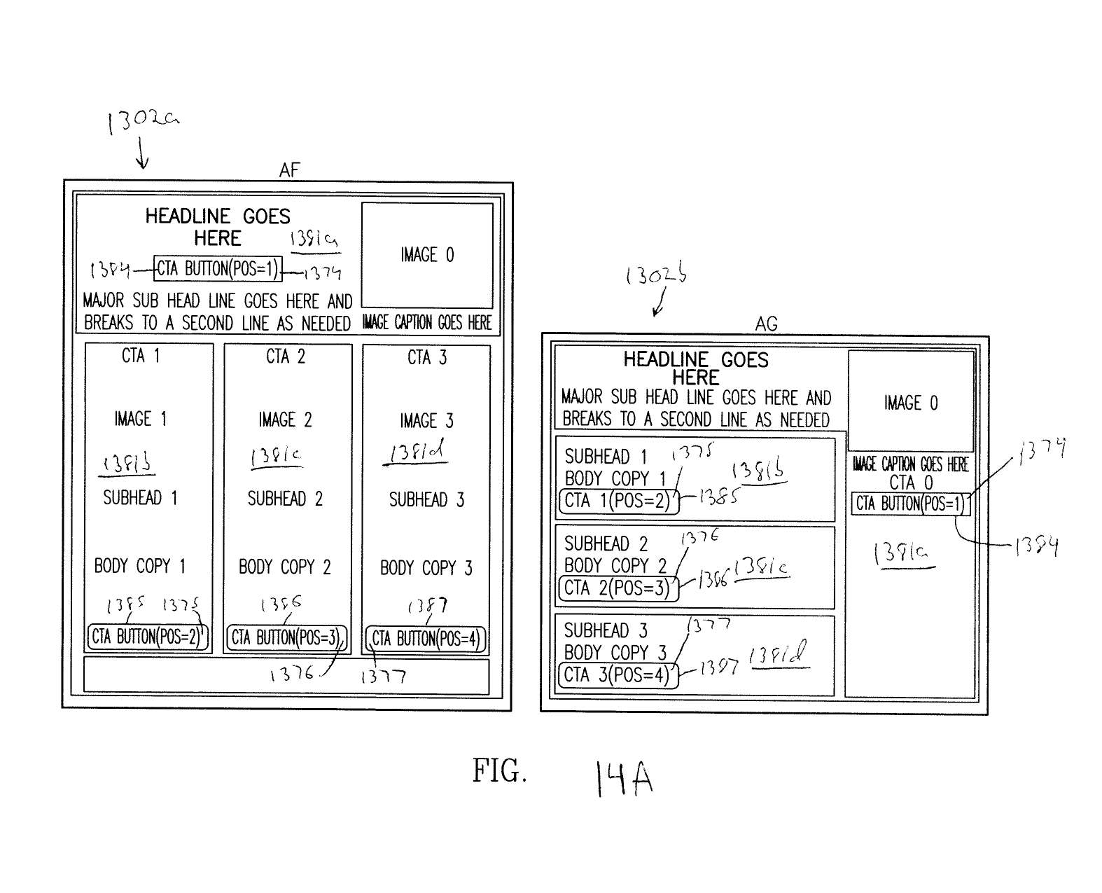

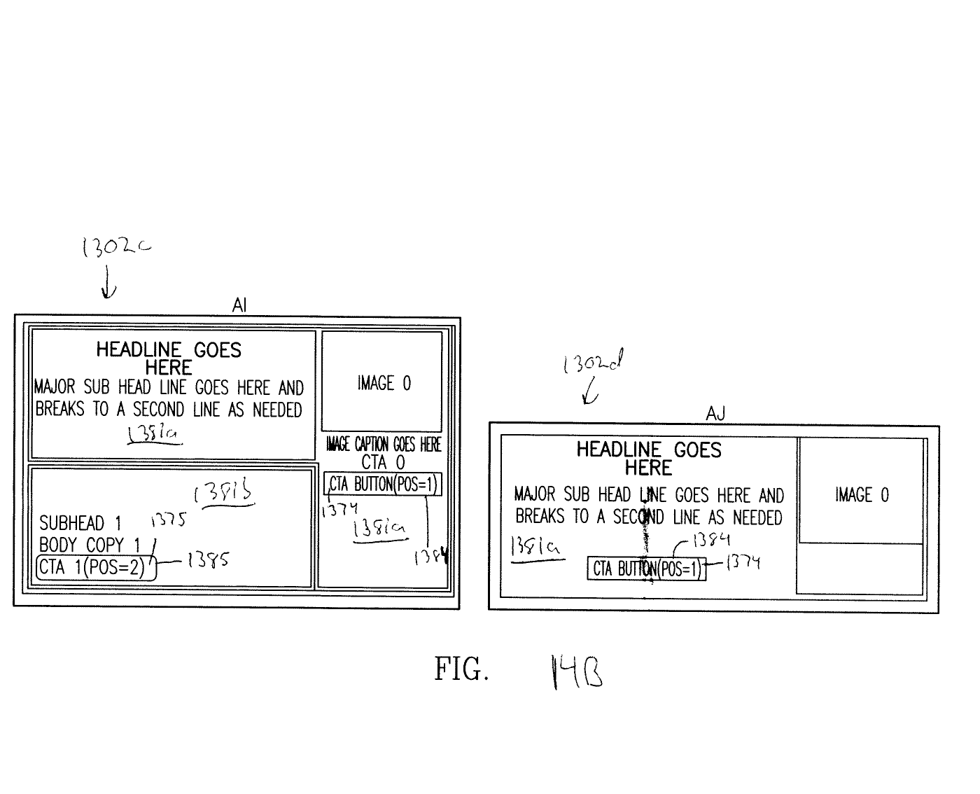

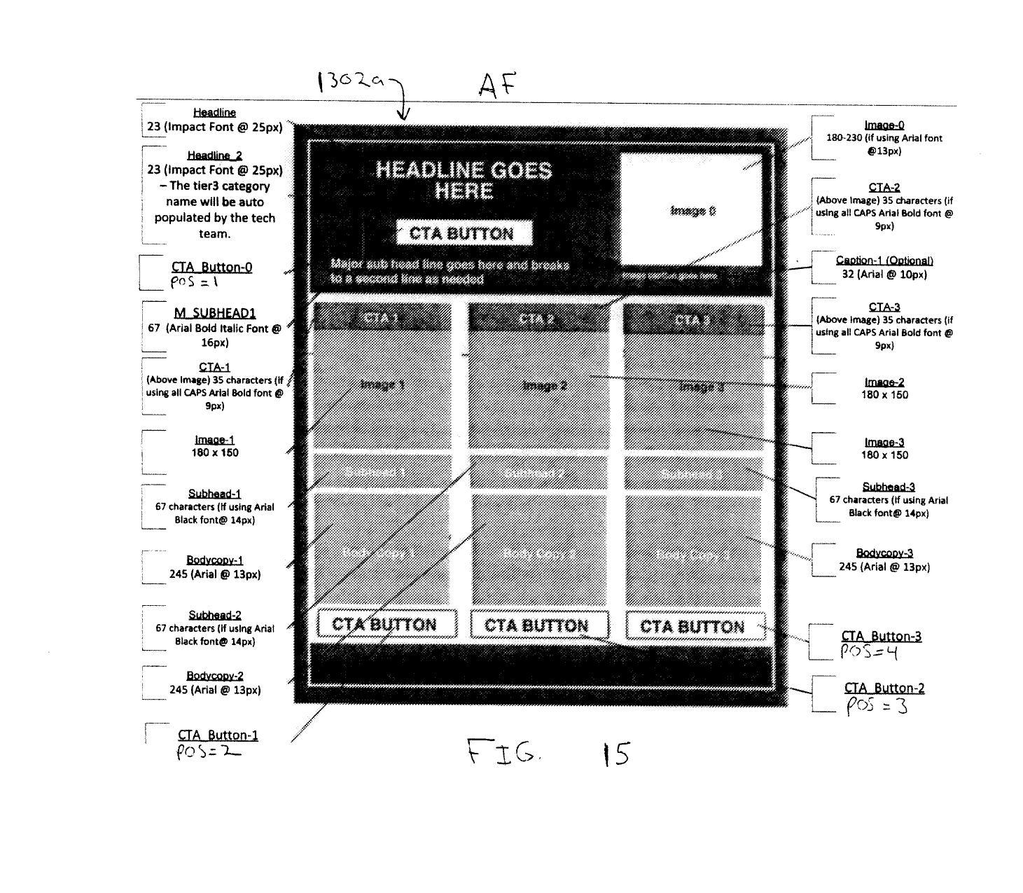

A sixth cache 32f is for templates and template data, and programs (instructions executable on a processor) for creating template variations from the master templates. For example, one series 1302 of templates 1302a, 1302b, 1302c and 1302d, of multiple series of templates stored in storage media 32f, is shown in FIG. 13, and in greater detail in FIGS. 14A and 14B, to which reference is now made. In this series 1302 of templates, there is a master template 1302a, formed of four portions 1381a-1381d. Each portion 1381a-1381d includes areas that support an image from a corresponding creative. Within each portion 1381a-1381d, are areas 1374-1377 for supporting hot spots of a creative, and areas 1384-1387 for supporting sub images of a creative. The creatives are detailed below and shown in FIGS. 9A, 9B, and 10, as detailed below.

A first variation, including a derivation or reformation of the master template 1302a forms a second template 1302b of the series. Another variation of the of the master 1302a, or the second template 1302b forms a third template 1302c, while another variation of the template for the master 1302a, or the templates for the second 1302b or third 1302c templates forms a fourth template 1302d. While templates have been shown, this is exemplary only, as variants of the master, or other templates of the series, may occur for as many different templates of a series are desired. FIG. 15 provides a diagram of the master template AF 1302a in further detail, which may be used in creating variation templates.

Other caches, databases, as well as numerous other additional storage media, both internal and external thereto, for numerous functions may also be part of the e-mail API server 32, and are designated 32n.

Content servers (CS) 34a-34n (one or more) are also linked to the Internet 24. The content servers (CS) 34a-34n provide content, for example, in text form, for the imaging server (IS) 38, typically through the home server (HS) 30 (for example, as data, code or the like from an image link returned to the home server (HS) 30, as detailed below), and, for example, in response to a request from the home server (HS) 30, as detailed below. These content servers (CS) 34a-34n may be, for example, Pay-Per-Click (PPC) servers of various content providers, such as internal providers, or external providers, for example, Overture Services, Inc., Miva, Inc., or Findwhat, Inc.

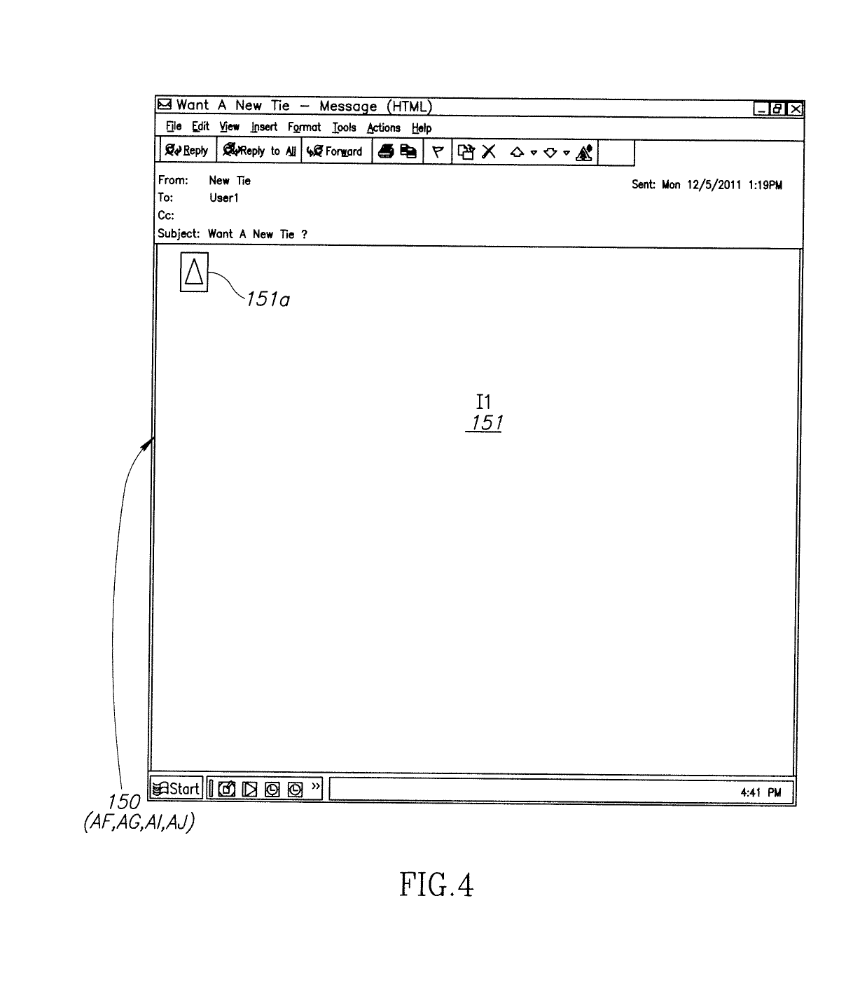

At least one imaging server (IS) 38 is linked to the Internet 24. The imaging server (IS) 38, representative of all imaging servers, functions to convert text (data in text format) from the home server (HS) 30, to an image (data in an image format). After the text is converted into an image, corresponding to the creative and the images covering the “hot spots” of the creative (collectively, “the creative”) (for example, in HTML code, from the e-mail API server 32), the image (for example, formed of multiple images to accommodate the “hot spots” as well) is typically sent back to the home server (HS) 30, and sent to a recipient server, for example, the proxy server 52, that sends the image to fill the template 150 (FIG. 4), once the e-mail is opened by user 41a, as detailed below. The imaging server (IS) 38 may store the requisite images corresponding to the data or code in the cache 32b (for example, placed into the requisite image links as detailed below) including all code, data and the like for all of the images associated with the creative, such as the main image for the body of the creative that include the hot spots and sub images that cover the hot spots (as detailed below), in the server itself, or storage devices or other servers linked to the imaging server (IS) 38. For explanation purposes, all devices and servers associated with storage of data to produce the requisite images in the electronic communications detailed herein, as represented by the imaging server (IS) 38.

The publisher server (P1) 50 may be one or more servers, components or the like, but is shown for description purposes as a single server. The publisher server (P1) 50 is of an architecture that includes databases 50a, 50b. For example, one database 50a stores one or more lists 50a′ of e-mail addresses of recipients or users 56a-56n. Another database 50b stores and maps e-mail addresses from the aforementioned lists 50a′ to their corresponding cryptographically hashed e-mail addresses by the md5 algorithm (md5s).

The publisher server (P1) 50 includes software and hardware allowing it to function as a mail (e-mail) transfer agent (MTA). The mail transfer agent (MTA) is shown, for example, as a module 50′ within the publisher server (P1) 50, but may be on a separate server or a separate component. The publisher server (P1) 50 and the mail transfer agent module 50′ are configurable to work with numerous types of e-mail clients, associated with various intended recipients (users), such as America Online® (AOL®), Eudora®, Microsoft® Outlook®, and other web-based clients.

The publisher server (P1) 50 includes programs for cryptographically hashing the aforementioned e-mail addresses of users 56a-56n (from the list 50a′) through the md5 algorithm, and sending the md5 corresponding to the e-mail address, to the e-mail API server 32. There is also software, hardware and combinations thereof for receiving the code of a creative and data including the code for a suggested template from the e-mail API server 32, along with additional data, coordinating it with an e-mail address from a list 50a′, and adding a header and footer to this acquired data, to create an electronic communication, for example, in the form of an e-mail. The e-mail is sent from the mail transfer agent (MTA) module 50′ to the intended recipient, for example, user 41a at the e-mail address user1@xyz.com, typically directly, but may be through the proxy server 52.

The publisher server (P1) 50 includes various processors, including microprocessors, for performing the aforementioned server functions and operations and storage media, either internal or associated therewith, as well as other server operations, including constructing the master template and variations thereof. Also, for explanation purposes, the Publisher Server (P1) 50 may have a uniform resource locator (URL) of, for example, www.P1server.com. The publisher server (P1) 50 is also typically electronically linked internally within the publisher entity 55 to the proxy server 52.

The proxy server 52 may be one or more servers, components or the like, but is shown for description purposes as a single server. The proxy server 52 is of an architecture that includes software, hardware, and the like for sending and receiving e-mail, receiving and sending image requests, and receiving and sending data to fill templates of opened e-mails. The proxy server 52 includes software and hardware allowing it to function as a mail (e-mail) transfer agent. The proxy server 52 is also programmable for static configurations, for example, to send requests received from users (from opened e-mails) to the home server (HS) 30 (as detailed below), and may also be programmed to be mapped to the home server (HS) 30 or other desired servers, components and the like.

The proxy server 52 includes various processors, including microprocessors, for performing the server functions and operations detailed herein and storage media, either internal or associated therewith, as well as other server operations. Also, for explanation purposes, the proxy server 52 may have a uniform resource locator (URL) of, for example, www.P1proxyserver.com.

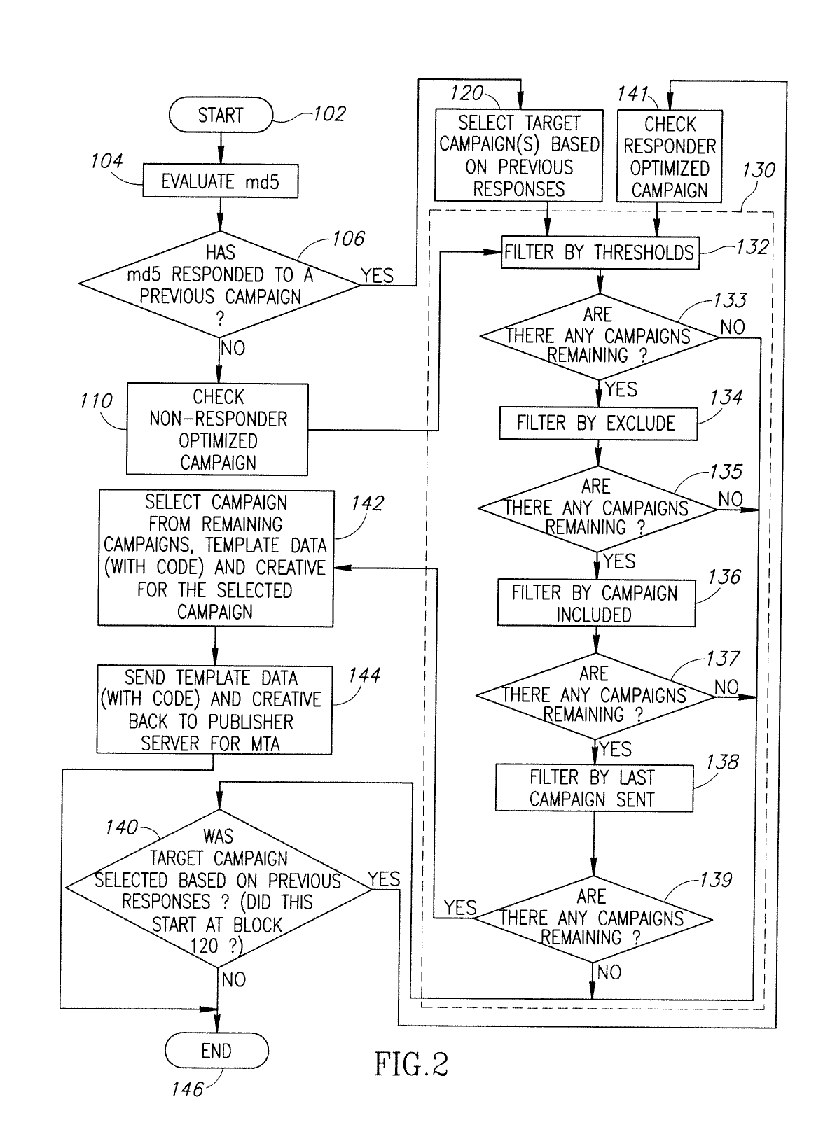

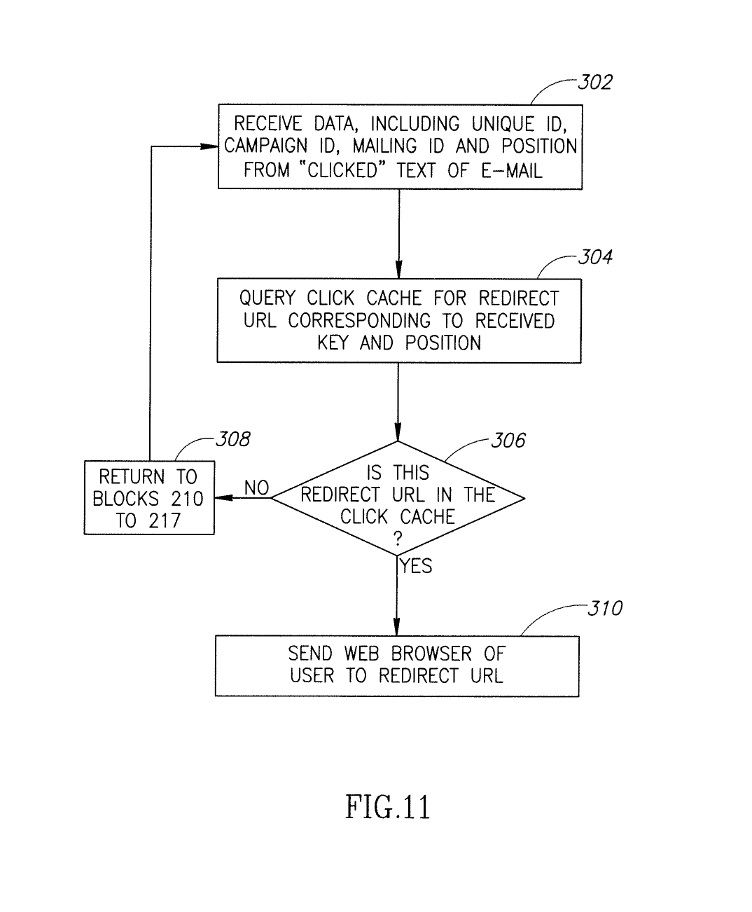

Turning also to FIG. 2, an exemplary implementation of a process in accordance with an embodiment of the disclosed subject matter will now be described. FIG. 2 is flow diagram of the process (method), for selecting the contents of the communication that the publisher 55 will send to the intended recipient (user), for example, user 41a. The process of FIG. 2 may be the first phase of a larger process. For example, the first phase may involve selecting a creative to be placed into an e-mail. In another phase, the e-mail is rendered to an e-mail client, by the publisher 55, as shown in FIG. 11 and detailed below. In another phase, the browsing application of the e-mail recipient or user is directed to a target web site, via a link, that is activated once the user 41a has clicked his mouse 41b on a portion of the image covering the dynamically rendered link, of the creative (supported by the requisite template), that appeared on the screen display of the user 41a when the e-mail was opened.

Initially, the computer 41b of the user 41a includes an e-mail client (detailed above), installed thereon, that provides the user with a unique address and the ability to utilize one or more e-mail addresses. For example, the user 41a has an e-mail address, user1@xyz.com, through which he receives his e-mail from the domain server 40, that hosts the domain xyz.com, of which the user 41a is a member. The computer 41b also includes a web browser, browsing software, application, or the like, to access web sites or web pages from various servers and the like, on the Internet 24. Some exemplary web browsers/web browsing software includes, Internet Explorer®, from Microsoft, Redmond, Wash., and Netscape® Navigator®.

Prior to the START, at block 102, the Publisher Server (P1) 50 pulls the data, including the codes for one or more templates of a series of templates available to them by the computer system, for example, the e-mail API server 32 (via storage media 32f). The series of templates, includes, for example, a master template or one or more variations thereof. Along with the aforementioned template data, the Publisher Server (P1) 50, may also pull a program for making template variations from the master template or variations thereof, from the computer system, for example, the e-mail API Server 32.

Also, prior to the start at block 102, typically within the publisher entity 55, the Publisher Server (P1) 50 pulls e-mails addresses from lists, for example, the list 50a′, stored in databases, for example, the database 50a. For example, the e-mail address of user1@xyz.com has been pulled from the list 50a′ from the database 50a. This pulling of the e-mail address is representative of actual operation for multiple e-mails pulled from one or more lists in one or more databases, by one or more publishers. The e-mail address, user1@xyz.com, is cryptographically hashed via the md5 algorithm in the publisher server (P1) 50, with data corresponding to the cryptographically hashed e-mail referred to hereinafter as an “md5.” The e-mail with the corresponding md5 is, for example, stored in the hash storage database 50b.

The publisher server (P1) 50 sends the md5 along with, data including, for example, an assigned image domain, for example, “www.p1proxyserver.com”, a click domain, for example, “www.p1proxyserver.com”, a list identifier, for example, “280”, the domain of the e-mail address, for example, “xyz.com”, and a threshold value, indicated as “level”, for example, “8”, to the e-mail API Server 32. This data is typically submitted as a string, for example, the string as follows:

```
<?xml version=“1.0” encoding=“UTF-8”?>
    <request>
        <email>
        <recipient>57e8c0b0ef702ab4eee91a644cdc51f5
        </recipient>
        <list>280</list>
        <domain>xyz.com</domain>
        <level>8</level>
    </email>
    </request>
```

This data from the publisher server (P1) 50 is now received in the e-mail API server 32, and the process of selecting and returning a creative and suggested template for the particular user, whose e-mail address corresponds to the md5, begins, at block 104.

The received md5 is compared against md5's of previous responders, stored in the cache 32a, in an evaluation process of block 104. It is then determined if this md5 was a previous responder, at block 106. This determination is made, for example, by checking the md5 against a cache, for example Responders Cache 32a, of previously received and stored md5s.

If this md5 is not matched with the md5 of a previous responder, the md5 is treated as a non-responder, and the process moves to block 110. In the process at block 110, the non-responder database 32b is checked for campaigns suitable for this non-responder md5. A campaign is selected for the non-responder md5, typically by selecting the “active” campaign among rotating campaigns (with each campaign of the rotating campaigns being “active” at predetermined intervals). The selected campaign is then subjected to filtration, at block 130, shown in broken lines.

Returning to block 106, if the md5 matches a previous responder md5, the process moves to block 120, where one or more target campaigns are selected based on the previous campaigns sent to the md5 responder. This target campaign(s) may be determined by numerous methods, for example, a rotating method of preprogrammed campaigns based on the previously responded to campaign(s), by the user, whose e-mail address corresponds to the md5. Alternately, a campaign for the user, whose e-mail corresponds to the md5 may be selected in accordance with one or more of the processes detailed in U.S. patent application Ser. No. 11/774,066, entitled: System And Method For Behaviorally Targeting Electronic Communications, filed on Jul. 6, 2007, the disclosure of which is incorporated by reference in its entirety herein.

With the campaigns now selected, non-responder optimized campaigns from block 110 or target campaigns form block 120 they are subjected to filtration, at block 130. The filtration process is shown in broken lines.

The filtration process of block 130 is now described. The filtration process of block 130 includes four sub-processes 132, 134, 136, 138. The filtration process of block 130 is, for example, controlled by the system administrator and may employ one or more of the sub processes 132, 134, 136, 138 in any combination and/or order.

For example, a first sub process at block 132 is filtration by thresholds. A threshold is a value provided by the publisher in the data sent to the e-mail API server 32, with the md5. These threshold values correspond to the levels in the API server 32 for the selected set of campaigns for the particular responder, in accordance with an identical scale used by the system administrators associated with the respective publisher servers, for example, server P1 50 and the e-mail API server 32. The process moves to block 133 to determine if there are any campaigns that meet the threshold. This determination is based on there being at least one campaign that meets or exceeds the threshold.

If there is not a campaign that meets or exceeds the threshold, the process moves to block 140, as detailed below. If there is at least one campaign that meets or exceeds the threshold, the process moves to block 134.

Block 134 involves filtration by exclusion. Excluded campaigns are campaigns specifically preprogrammed not to be sent to the particular md5 being evaluated. It is then determined, at block 135 if there are any campaigns left as a result of the filtration by exclusion. It there are not any campaigns left after filtration by exclusion, the process moves to block 140, as detailed below. If there is at least one campaign remaining, the process moves to block 136.

Block 136 involves filtration by inclusion. Included campaigns are campaigns specifically preprogrammed that the md5 being evaluated may receive. It is then determined, at block 137 if there are any campaigns left as a result of the filtration by inclusion. It there are not any campaigns left after filtration by inclusion, the process moves to block 140, as detailed below. If there is at least one campaign remaining, the process moves to block 138.

Block 138 involves filtration by the last campaign sent to the md5 being evaluated. This filtration step avoids the same campaign being sent twice to the particular md5, and in particular, the user associated with the e-mail address associated with the md5. If the campaign to be sent is the same as the previous campaign designated to be sent to that particular md5, the campaign will not be sent. The process moves to block 139, where it is then determined, if there are any campaigns left as a result of the filtration by last sent campaign.

Moving from block 139, and also returning to blocks 133, 135 and 137, if there are not any remaining campaigns, the process moves to block 140. At block 140, it is determined whether this responder entered the filtration process of block 130 with targeted campaigns selected based on previous responses (did the process start at block 120). If yes at block 140, the process moves to block 141, where the responder optimized database 32c is checked to determine the responder campaigns. These responder campaigns are typically one or more campaigns predetermined for predetermined random responders according to programs or simply random. Once such campaigns are obtained, the process returns to block 130, and continues as detailed above. If no to block 140, the process moves to block 146, where it ends.

If there is at least one campaign remaining at block 139, the process moves to block 142. At block 142, a campaign is selected from the remaining campaigns and template data including a code for the suggested (recommended) template, for example, from a template series, is selected. For example, the campaign selected could be a previously ordered or random campaign selected manually or by a program in the system. It could also be the campaign with the highest rank as per the process disclosed in U.S. patent application Ser. No. 11/774,066. Also within block 142a creative for the campaign and the suggested template is selected. This creative is for example, the active creative, for example, selected on a rotating basis, from each creative of the series of creatives being active at predetermined intervals. Alternately, any other selection method for the creative is also suitable.

The process moves to block 144, where data for the creative, along with other data, including the template data with the code for the selected template for supporting the creative, is sent back to the publisher server (P1) 50 (and received by the publisher server 50). The process ends at block 146 until the next md5 is received in the e-mail API server 32.

Turning back to block 144 in detail, data, for example, in the form of a data string, that, for example, includes data for the selected creative, as well as additional data, such as the code of the template data, is sent back to the publisher (P1) server 50. The data for the creative includes one or more click links and image links. The click link(s) are for example, addresses of the proxy server 52 of the publisher 55 and the image links are used to obtain the creative. The image links also serve as the “requests”, also known as content requests, as they are employed in the content generation processes detailed herein. The click links and image link include embedded data read by the servers or components, for example, the home server (HS) 30, that provide the images for the creative (main image and images for the hot spots of the main image, via the imaging server (IS) 38), activatable links for the hot spots, and data for redirecting the browser or browsing application of the intended recipient (user) of the electronic communication to a URL corresponding to the activatable link of the requisite hot spot, once the activatable link has been activated or clicked.

The additional data includes the md5 (md5 hash of the intended recipient's e-mail address), that serves as a unique identifier (UID), a list identifier, indicative of the list from the particular publisher from which the md5 is based, a mailing identifier (MID), a campaign identifier (CID) and a creative identifier (CCID). This data is utilized by the publisher server (P1) 50 to place the image link and click links for the requisite creative, and the computer (central) system-selected template into the correct electronic communication, for example, the requisite e-mail for the intended recipient (user).

The data representative of the requisite creative for the requisite intended recipient (user) (for the selected campaign), for example, a string, is as follows:

<?xml version=“1.0” encoding=“UTF-8”?>
<result>
<email>
<recipient>57e8c0b0ef702ab4eee91a644cdc51f5</recipient>
<list>280</list>
<creative>
<dname><![CDATA[New Tie]]></dname>
<from><![CDATA[Newtie]]></from>
<subject><![CDATA[Want a New Tie?]]></subject>
<body><![CDATA[<imgsrc=“http://p1proxyserver.com/ai/Y2lkPTEwMT-
kxJnF0PTQ
maW09MSZ1PTU3ZThjMGlwZWY3MDJhYjRlZWU5MWE2NDRjZGM
1MWY1Jm09MTAwMDAmbGlkPT
l4MCZzaT0zJmNoPWh0dHAlM0ElMkYlMkZkeW4uYWsyLmNjJTJGb
2MlMkYxMDElMkYxMDE5M
SUyRnF0Y2gmZG49b3RoZXlmY2w9OX1r0JDr_EzeQ0ujNbp7Plc”
border=“0”
usemap=“#x”>
<map name=“x”>
<area coords=“240,167,528,290”
href=“http://p1proxyserver.com/ac/
Y2lkPTEwMTkxJmltPTEmdT01N2U4YzBiMGVmN
zAyYWl0ZWVlOTFhNjQ0Y2RjNTFmNSZtPTEwMDAwJmxpZD0yOD
Amc2k9MyZkbj1vdGhlciZj
bD05JbVupPutGlG1-DLJLeaCrQ”> <area coords=“238,335,526,450”
href=“http://p1proxyserver.com/ac/
Y2lkPTEwMTkxJmltPTlmdT01N2U4YzBiMGVmN
zAyYWl0ZWVlOTFhNjQ0Y2RjNTFmNSZtPTEwMDAwJmxpZD0yOD
Amc2k9MyZkbj1vdGhlciZj bD05TetWeCXlF09gCJ2KpkB2wQ”>
</map> ]]>
</body>
</creative>

In this string, going from top to bottom, the <recipient>is the unique identifier, and includes the md5 hash of the email address (md5). The list identifier is represented by the <list>, and specifically, the list is “list 280” from publisher P1.

The actual creative is represented by <creative>, and is formed of multiple segments. The segment indicated by <dname> is the display name for the “From” line in the e-mail that is sent by the publisher to the intended recipient with this returned string. The segment indicated by <from> is the user name for the “From” line of the e-mail that is sent by the publisher to the intended recipient with this returned string. The segment <subject> is the “Subject” line of the e-mail that is sent by the publisher to the intended recipient with this returned string.

The <body> is the content for the creative that has been determined for the particular recipient (user). It is for example, in two parts, the image link, and one or more click links (depending on the number of “hot spots” to be filled in the creative, corresponding to the image link, as detailed below). The aforementioned data is the additional data that accompanies the image link and the click link(s) in the data string.

The image link is represented, for example, by the line:

<imgsrc=“http://p1proxyserver.com/ai/
Y2lkPTEwMTkxJnF0PTQmaW09MSZ1PTU3ZT
hjMGlwZWY3MDJhYjRlZWU5MWE2NDRjZGM1MWY1Jm09MTAw
WDAmbGlkPTl4MCZzaT0zJmNoP
Wh0dHAlM0ElMkYlMkZkeW4uYWsyLmNjJTJGb2MlMkYxMDElMk
YxMDE5MSUyRnF0Y2gmZG49
b3RoZXlmY2w9OX1r0JDr_EzeQ0ujNbp7Plc” border=“0” usemap=
“#x”>

This image link is encoded to include the image source, for example, the imaging server 38, as indicated by the address “p1proxyserver.com.”, for the proxy server 52, that is mapped to the home server (HS) 30, indicated by “ai” in the image link. The home server (HS) 30 is mapped to the imaging server (IS) 38 to pull the images for the creative, for example, the main image (that includes locations corresponding to the hot spots) and the images, also known as sub-images, for the hot spots, detailed below. The image link includes the number of listings (N) as a listing count, and reference to the locations of the positions for the hot spots (and the links obtained from the listings that are placed into the hot spots) inside the creative. For example, if there were two positions inside the creative (for example, corresponding to two click links), the position data (POS) would be such that the positions are represented by POS=1 and POS=2, and N=2, for example, creative AI-C 270c of FIGS. 9B and 10, as supported by the template AI 1302c of FIGS. 13 and 14B. As the system of the home server 30, API server 32 and imaging server 38 is scalable, the same holds true for four positions, N=4, with positions represented by POS=1, POS=2, POS=3, and POS=4 (for example, creatives AF-C 270a and AG-C 270b of FIG. 9A and FIG. 10, as supported by the templates AF 1302a and AG 1302b, respectively, of FIG. 13 and FIG. 14A), and similarly, for three positions, where N=3. Additionally, the same holds true for one position, where N=1 (for example, creative AJ-C 270d of FIG. 9B and FIG. 10, as supported by the template AJ 1302d of FIG. 13 and FIG. 14B).

The click links, for example, the two click links are represented, as follows, for example, the first click link:

href=“http://p1proxyserver.com/ac/
Y2lkPTEwMTkxJmltPTEmdT01N2U4YzBiMGVmN
zAyYWI0ZWVlOTFhNjQ0Y2RjNTFmNSZtPTEwMDAwJmxpZD0yOD
Amc2k9MyZkbj1vdGhlciZj bD05JbVupPutGlG1-DLJLeaCrQ”>

for the first position POS=1 in the creative; and,

the second click link:

href=“http://p1proxyserver.com/ac/
Y2lkPTEwMTkxJmltPTImdT01N2U4YzBiMGVmN
zAyYWI0ZWVlOTFhNjQ0Y2RjNTFmNSZtPTEwMDAwJmxpZD0yOD
Amc2k9MyZkbj1vdGhlciZj bD05TetWeCXIF09gCJ2KpkB2wQ”>

for the second position POS=2 in the creative.

The click links provide an internet protocol address for directing the HTTP request.

The unique identifier (UID), for example, the md5 of the recipient (user), mailing identifier (MID), campaign identifier (CID) and creative identifier (CCID) are embedded as code into the respective image link and click links. The click links also include position data (POS) for their respective positions in the creative (as defined by the hot spots). For exemplary purposes, the unique identifier (UID) is, for example, “57e. . . 51f5”, the mailing identifier (MID) is, for example, “1000,” the campaign identifier (CID) is, for example, “110191”, while the creative identifier (CCID) is, for example, “15398”. The mailing identifier (MID), campaign identifier (CID) and creative identifier (CCID) are typically not used by the publisher, but are used by the entity providing the creative and providing the content thereto (for example, the entity that controls the home server (HS) 30, e-mail API Server 32 and/or imaging server 38). The aforementioned identifiers are used in combination with other data to process the request and redirect the browser of the intended recipient (the user), when they activate one of the links of the creative, upon opening their e-mail, as detailed below.

Once this data is received in the publisher server (P1) 50, the md5 is converted to an e-mail address by virtue of the md5 being mapped back to the e-mail address in the hash database 50b of the publisher (P1) server. A header and footer is placed onto this received data, i.e., the data string, by the publisher, for example, the publisher (P1), at the publisher server (P1) 50. The e-mail address of the intended recipient is obtained from the hash database 50b, as the md5 is mapped back to the e-mail address of the intended recipient (user). The packaged data, including the header, footer and the data string is now an electronic communication, and is sent from the MTA module 50′ as, for example, an e-mail to the intended recipient, for example, the intended recipient, such as, the user 41a, at the e-mail address user1@xyz.com.

The data placed into the e-mail also includes a program that provides the body of the e-mail when the e-mail is opened. The program provides a template 150 (FIG. 4), for example, the suggested template from the e-mail API Server 32 from the template series, such as one of templates AF 1302a, AG 1302b, AI 1302c, AJ 1302d, of FIG. 13, FIG. 14A and FIG. 14B, as provided by the publisher server 50 upon obtaining the template data, including the code for the suggested template (for example, one of template AF 1302a, AG 1302b, AI 1302c, AJ 1302d), as received from the API server 32, as detailed above. The template 150 forms the basic structure or framework for the image(s) of the opened e-mail, and, zero or more HTTP Source requests for zero or more static images. The sent e-mail may also include HTML constructs and text, such as plain text, HTML headers, list constructs and the like.

The unique identifier (UID) is, for example, the md5 hash (md5) corresponding to the e-mail of the intended recipient, as per the publisher, from the list 50a′ of the publisher. This md5 guarantees uniqueness for the particular received request(s).

The mailing identifier (MID) is a sequence of characters indicative of the batch from which the particular creative was sent. For example, a mailing identifier may be a sequence of numbers.

The position data is data indicative of the location in the template and the creative of the “hot spots” where activatable locations (images within the main image) that cover activatable links, are placed dynamically into these positions in the creative. By dynamically, it is meant that the activatable links are placed into the “hot spots” at the time the e-mail is opened, as detailed below. The number of hot spots or activatable links in a creative is represented by N, with the number of hot spots or activatable links in the creative being code embedded in the image link, and the number of click links, as detailed above.

These activatable locations (e.g., sub images 284-287 FIGS. 9A, 9B and 10) cover the activatable links, that when activated or “clicked” on, will ultimately redirect the browser or browsing application associated with the intended recipient, to a target web site, for example, a web site hosted fully or partially by a third party server (TPS) 42a-42n, associated with the requisite link. The position data is represented by “POS” and a creative and corresponding template with two positions or “hot spots” includes two positions, POS=1 and POS=2. These two positions result in a Max Number or listing count (N) being equal to “2”, corresponding to the two positions for links, as the creative includes two “hot spots.”

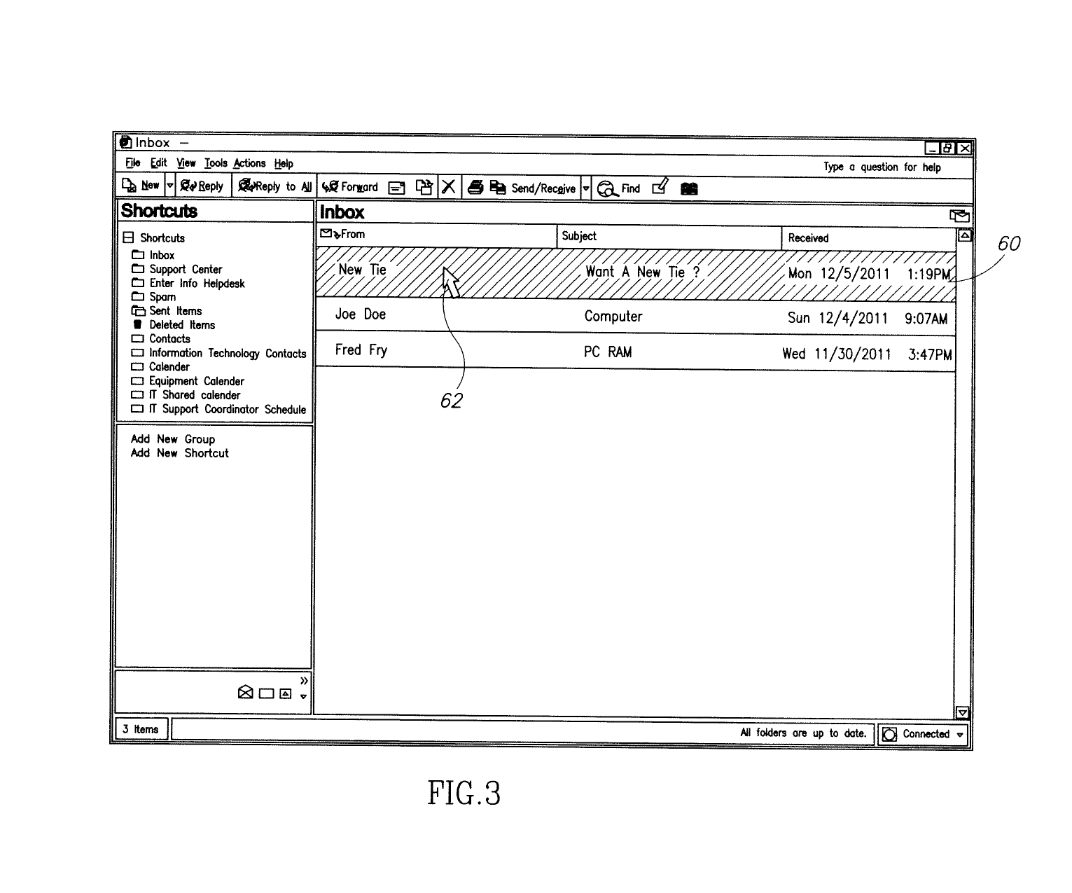

An e-mail is now sent by the MTA module 50′ of the publisher server (P1) 50, to the intended recipient, for example, the user 41b, with the e-mail address user1@xyz.com. This initially or first sent e-mail, for explanation purposes, is referred to as the “sent e-mail.” The sent e-mail is received in the intended recipient's or user's mail box, as shown in FIG. 3, as a text line 60.

When the e-mail (the sent e-mail) is downloaded by the e-mail client of the user 41a, the e-mail client opens a connection or “pipe” to the Proxy Server 52, by virtue of being mapped thereto. The e-mail client associated with the computer 41b of the user 41a, pulls data from the Proxy Server 52, and may pull data asynchronously. The data pulled from the Proxy Server 52 includes data required to display the resultant creative (in the form of images), for example, a template 150, in the image area I1 151, as shown in FIG. 4. The representation of the image for the creative is the box 151a The user 41a opens this e-mail, typically by clicking the mouse 41c (of the computer 41b), as shown by the arrow 62, anywhere along the line 60, that represents the sent e-mail as received in the user's mail box, as shown in FIG. 3. This opening, for purposes of explanation herein, occurs at a time indicated as t₁ The e-mail client, associated with the e-mail address of the intended recipient or user, i.e., user1@ xyz.com, pulls data from the home server (HS) 30, through the proxy server 52. This pulling of data by the e-mail client is continuous, typically automatic and in real time, as long as the request is being processed, as described below.

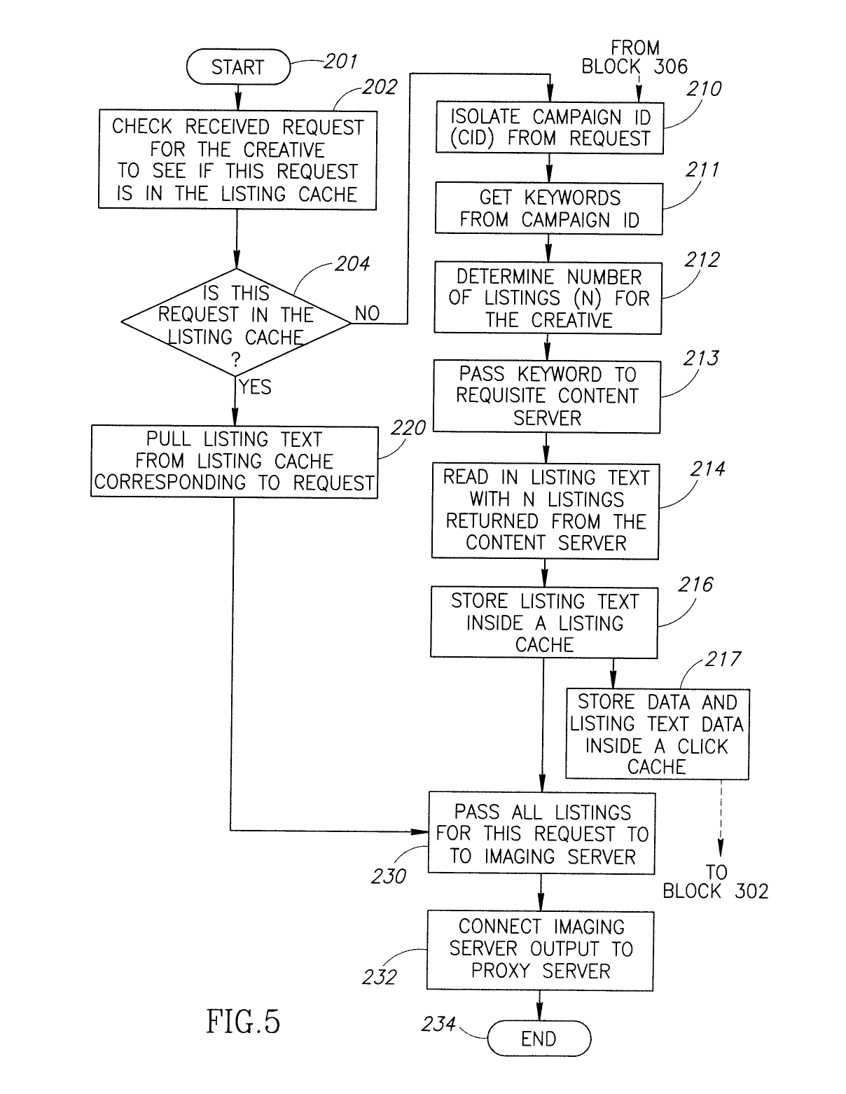

There is now a connection or “pipe” opened between the user's computer 41b and the proxy server 52, and the home server (HS) 30, as the proxy server 52 maps to the home server (HS) 30, as per the image link of the creative, detailed above. The proxy server 52 receives the request (e.g., a content request), which was automatically transmitted from the recipient's computer (terminal), once the electronic communication (e.g., e-mail) is opened (for example, by the user making a mouse click). The request is, for example, the image link associated with the creative, and the proxy server 52, for example, automatically passes the request to home server (HS) 30. The proxy server 52 is preprogrammed to send (for example, automatically) requests received from recipients (users) onward to the home server (HS) 30. With the request (content request) received in the home server (HS) 30, the creative corresponding to the creative identifier (CCID) in the image link is extracted and the data for the corresponding image (for example, the main image for the creative that includes the locations for the hot spots) is pulled from the imaging server (IS) 38, where its image data is stored, and is sent back to the proxy server 52. The data for the image is sent onward to the e-mail client for placement into the template 150 in the image location I1 151 in replacement of the box 151a, as shown in FIG. 4. The aforementioned process typically is automatic and in real time. The process of processing the request, as shown in FIG. 5, begins.

Turning to flow diagram of FIG. 5, the process is shown for processing received requests. The process begins at the start 201, typically, the request being received in the home server (HS) 30, as sent or pushed to it by the proxy server 52. In this process, requests are processed one at a time, on a “first in” basis. Processing of the one or more requests, typically occurs automatically, in real time, and sequentially, until there are not any more requests to process. Each request, for example, a single request from each intended recipient, received upon the opening of the e-mail, is cataloged in the request cache 43b, for example, for tracking purposes, by the entity providing the content of the e-mail (for example, the entity associated with the home server (HS) 30, e-mail API server 32, and/or the imaging server 38).

Initially, the home server (HS) 30, upon receiving the request (content request), at block 202, checks the received request to determine if the request has generated listings in the listing cache 43c. It is then determined if the request is in the listing cache 43c, at block 204.

The checking is performed as the home server (HS) 30 extracts the unique identifier (UID), for example, the md5, the campaign identifier (CID), and the mailing identifier (MID), from the image link of the received data string. These three data components are grouped to define a key, in accordance with the rules and policies of the home server (HS) 30. The key is queried against all keys in the key cache 43a for a match. Matching keys may be of identical or similar keys, in accordance with predetermined rules and/or policies programmed into the component(s) of the home server (HS) 30.

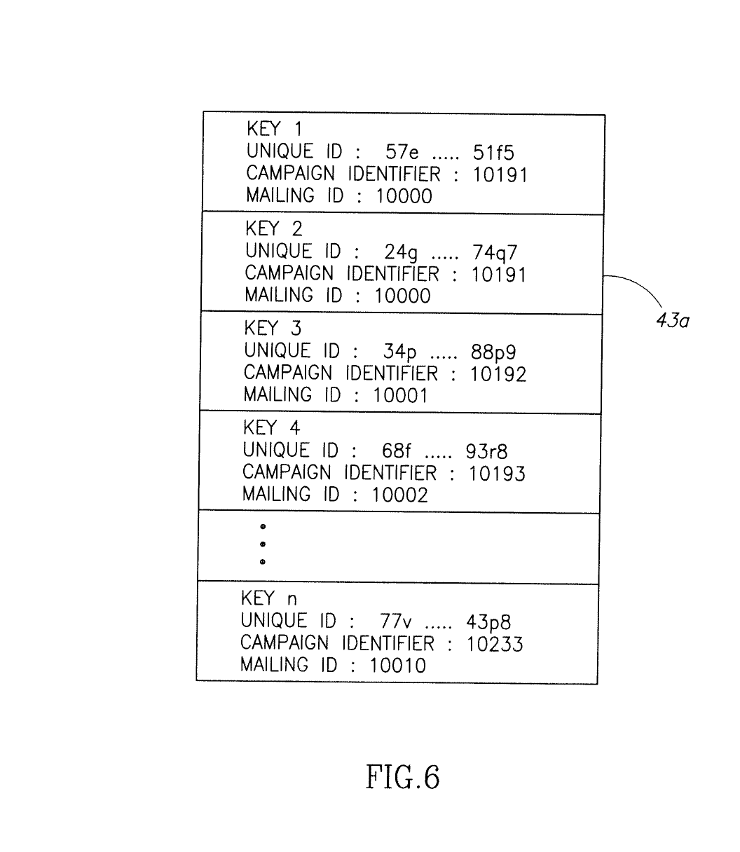

If a matching key is not found, this request has not been processed, and the process moves to block 210. Additionally, the unique identifier (UID) plus the campaign identifier (CID) and the mailing identifier (MID) becomes a key and is stored in the cache 43a, as shown, for example, in FIG. 6.

If a matching key is found, the listing cache 43c is searched for that key, to see if the key is in the listing cache 43c, with listings having been pulled for that key. If the key is not found in the listing cache, or found without listings, the process also moves to block 210.

Alternately, if the key is found with listings, the process moves to block 220. This is a non-typical occurrence, and takes place, for example, when the same recipient (user) opens the e-mail (line 62 in FIG. 3), another time, within a predetermined time. This predetermined time may be, for example, anywhere from the time the e-mail was initially opened to the time of a time out, for example, approximately five minutes after the initial opening and a creative does not appear on the screen of the user.

At block 220, the request has generated listings in the listing cache 43c. The listings form the listing text, with the number of listings in the listing text corresponding to positions for links in the “hot spots” of the creative. The number of positions in the creative for “hot spots” for supporting images with underlying links, is determined from the image link for the creative from the returned data string, as detailed above. The listings are subsequently pulled from the listing cache 43c, to be passed (sent) to the imaging server (IS) 38, at block 230, detailed below.

As shown in FIG. 6, keys in an example key cache 43a are indicated as KEY 1 to KEY 4. Each key is unique to each opened e-mail for a particular recipient (user), in accordance with the time each e-mail was opened. For, example, KEY 1 includes the md5 “57e . . . 51f5”, that is the unique identifier (UID), the campaign identifier (CID) is 10191, and the mailing identifier (MID) is 10000. KEY 2 through KEY n are formed of the same components, the md5, as the unique identifier (UID), the campaign identifier (CID) and the Mailing Identifier (MID).

Turning to block 210, the request being processed was determined not to be in the listing cache. The campaign identifier (CID) associated and sent with the request is isolated. The campaign identifier (CID) is typically in the form of alphanumeric data. The campaign identifier is matched with a corresponding campaign in a cache 43d, each campaign associated with one or more keywords (data representative of one or more keywords), at block 211. Remaining in block 211, one keyword is selected, typically the active keyword at that time. The keyword may be an actual keyword, or a keyword group identifier. The keyword is translated into data, recognizable and usable by the requisite content servers (CS) 34a-34n.

The process now moves to block 212, where the keyword (data corresponding to the keyword) is read, and in accordance with the reading, it is passed to a designated content server (CS) 34a-34n, over the Internet 24. The passing to the specific content server is typically in accordance with one or more rules, preprogrammed into the home server (HS) 30 or by a policy processor associated with the home server (HS) 30. The policies and/or rules are typically time-sensitive, to be applicable in real-time. For example, the keyword may be such, that once read, the preprogrammed rules will be applied. The keyword data will be passed to a specific content server, such as content server (CS) 34a, over the Internet 24.

The content servers (CS) 34a-34n return one or more listings. The listings may be in a prioritized order or random. For example, one or more of the content servers (CS) 34a-34n may be for Pay Per Click (PPC) advertising content. Alternately, the keyword can be passed to a content server (CS) 34a-34n that performs a search engine function.

The requisite content server 34a-34n will generate a listing text of N listings. N is the number of “hot spots” for supporting activatable links in the creative. The number of listings “N” for the particular listing text is determined at block 213, by examining the image link for the selected creative, for example and look for the number of listings embedded in the image link, as read by the logic of the home server (HS) 30, that provides the number of listings (N), to be returned from the requisite content server 34a-34n, the N listings corresponding to the number of “hot spots” in the requisite creative.

The content server (CS) 34a-34n, for example, content server (CS) 34a, that received the passed keyword (keyword data), is queried for acceptance of the keyword (keyword data), and returns a listing text to the home server (HS) 30. This listing text is read into the home server (HS) 30, with N listings, corresponding to the number of “hot spots” in the creative, at block 214. Data exchanges, between the home server (HS) 30 and the content server (CS) 34a (representative of all content servers (CS) 34a-34n), are, for example, accomplished via Extensible Markup Language (XML).

The listing text, that is returned to the home server (HS) 30 from the content server (CS) 34a, is assigned a particular key, corresponding to the new key created in the key cache 43a (as a result of a matching key not being found). The listing text typically includes the top “N” results, in the form of N listings, N being the total number of positions in creative, as determined from the image link associated with the selected creative. Each listing of the listing text for each key typically includes a title or headline for the content (e.g., the advertisement) to be returned to the e-mail client of the recipient user 40, at least one target uniform resource locator (URL) for one or more servers, such as third party servers (TPS) 42a-42n, and data for the content, typically in the form of listings, to be returned. The data for the creative to be returned includes data in text form and position data, indicating the location for the data in text form in the creative, for example, as shown in FIG. 9B, as data in text form that fills the hot spots 274, 275 in the creative AI-C 270c (the creative 270c including main images 281a, 281b, and sub images 284, 285 for the hot spots 274, 275, as supported on the corresponding template 1302a-1302d-Each template including an area for supporting a main image 1381a-1381d, a sub image 1384-1387 and hot spots 1374-1377 of FIGS. 13, 14A and 14B). The aforementioned portions of the listing text can be parsed, in accordance with the process being performed thereon.

The listing text is then stored in a cache, for example, the listing cache 43c, at block 216. The key assigned to the listing text, upon its being stored in the listing cache 43c, is linked to its corresponding key, typically in another cache, such as the key cache 43a.

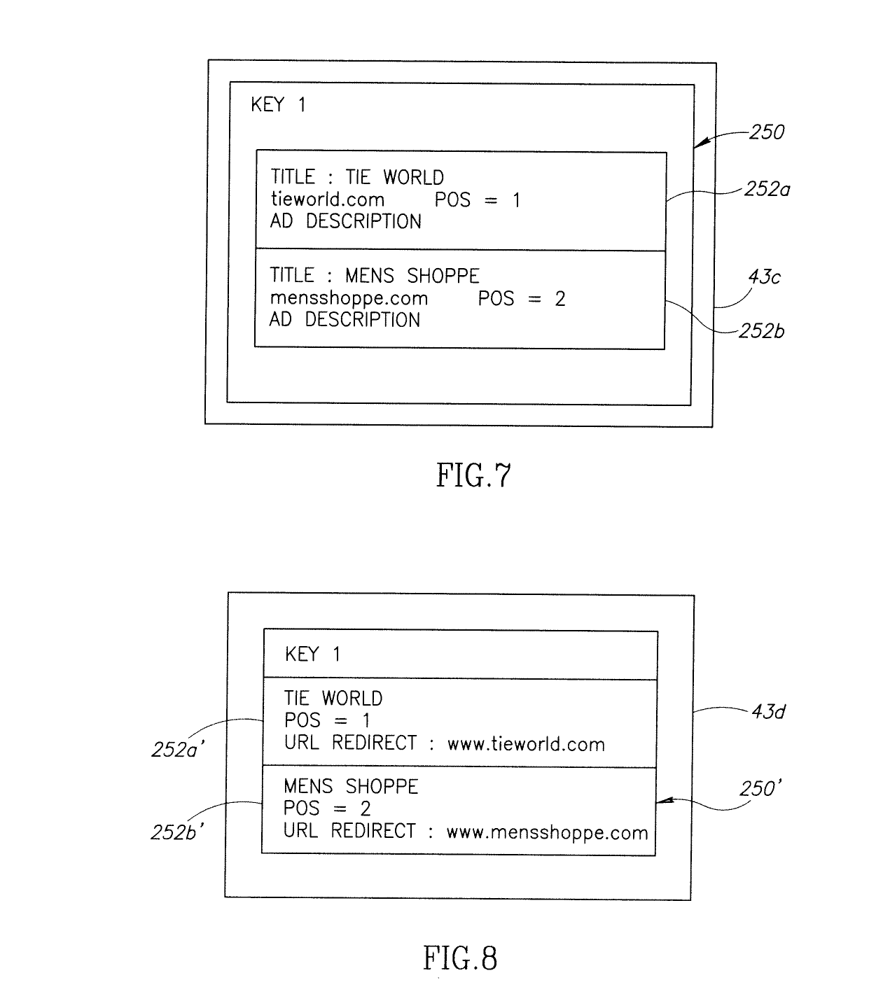

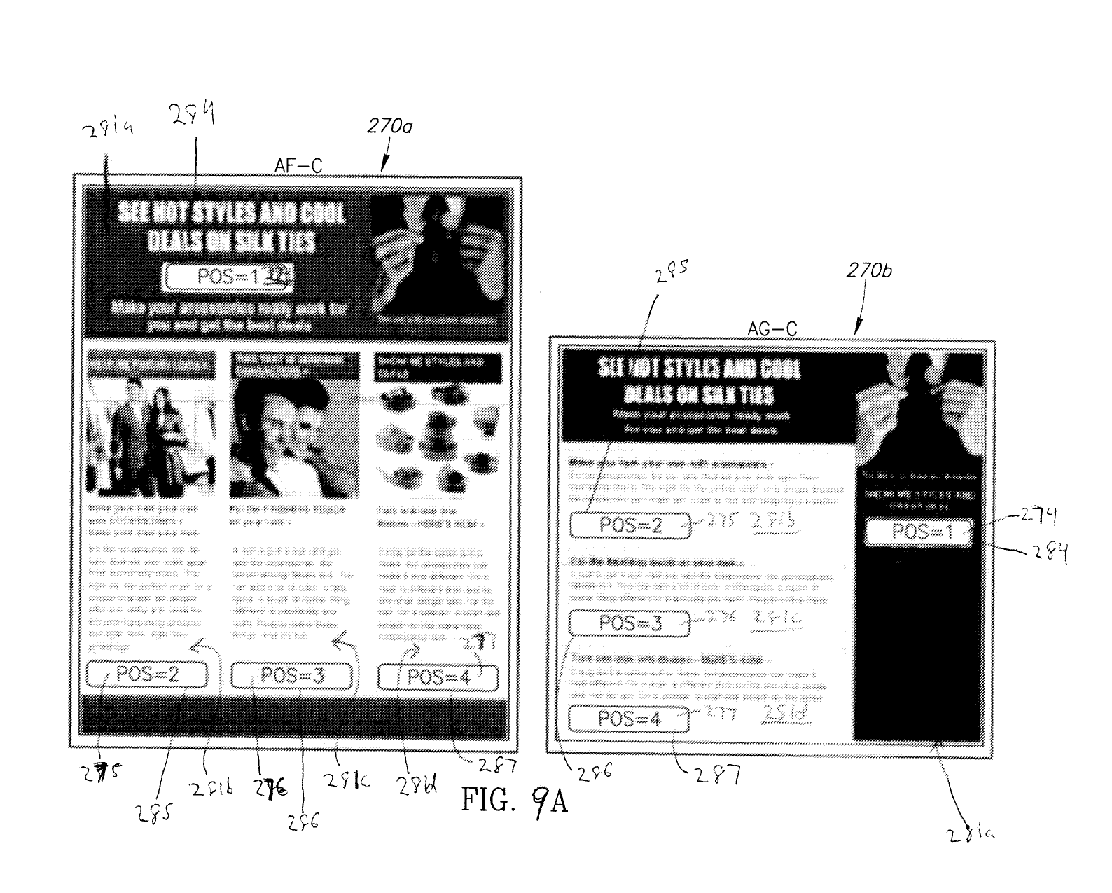

FIG. 7 shows an exemplary listing cache 43c, where a listing text 250 is stored therein. The listing text 250 includes a key, for example, KEY 1, formed of the unique identifier (UID), for example, an md5, the campaign identifier (CID), for example, “10191” and, the mailing identifier (MID), for example, “10000”, as shown in FIG. 6 and detailed above, and two listings 252a, 252b, where N=2. Within each listing 252a, 252b is, for example, a title for a web site associated with the listing (for example, in listing 252a, the title is TIE WORLD), a URL for the web site associated with the listing (for example, in listing 252a, the URL is www.tieworld.com.com), position data indicating the location of the “hot spot” in the creative where the image with the link to the web site associated with the listing (for example, in listing 252a, the position data is, POS=1), and data for the body of the content to be returned is referenced as “AD DESCRIPTION”. The AD DESCRIPTION is the text to be sent to the imaging server (IS) 38 with the TITLE, to be converted into the requisite image, for placement into the requisite “hot spot” of the creative at the requisite position. The listings 252a, 252b are typically placed into the listing text in an order of priority, here, for example, top to bottom or 252a, 252b. Additionally, by storing the listing text in the cache 43c with a unique key, a specific user, matched via the md5, will receive listings intended for him at the time he opened the e-mail (for example, should the user 41a at e-mail address user1@xyz.com, the time of opening the e-mail is time t₁).

Portions of the listing text are also stored in another cache, for example, a click cache 43d, at block 217. FIG. 8 shows an exemplary click cache 43d, where a listing text 250′, corresponding to the listing text 250 of the listing cache 43c, is stored in the click cache 43d. The listing text 250′ includes a key, identical to the corresponding key in the key cache 43a, as well as N, here, for example, two, listings 252a′, 252b′. Each listing 252a′, 252b′ corresponds to the listings 252a, 252b of the listing text 250. Within each listing 252a′, 252b′ is, for example, a title for a web site associated with the listing (for example, TIE WORLD in the listing 252a′), a Redirect URL for the target web site associated with the listing (for example, www.tieworld.com, in the listing 252a′), and Position Data indicating the location of the “hot spot” for the resultant image and the underlying link in the creative. For example, position data in the listing 252a′ is represented as POS=1, for placement of the link to direct a browsing application to the target web site at the designated first “hot spot” with POS=1 in the creative (for example, creative AI 270c).

From block 216, the process moves to block 230, where the listing or listings, depending on the number of “hot spots” in the creative, are passed from the listing cache 43c of the home server (HS) 30 to the imaging server (IS) 38. This passing is typically over the Internet 24. The imaging server (IS) 38 typically processes the passed listings from the listing cache 43c on a FIFO (first in first out) basis, with the position numbers dictating the order of processing, for example, lowest to highest, POS=1 before POS=2, and so on.

The imaging server (IS) 38 receives the listing in a text format and sends it to the home server (HS) 30, for placement it into the creative (main image or body of the creative) 270 in accordance with the correspondingly numbered “hot spots”, for example two “hot spots” 274, 275, for the positions (POS=1) 274 and (POS=2) 275. The creative 270c, with its hot spots 274, 275, is shown diagrammatically in FIG. 9B and FIG. 10-these two figures showing the series of corresponding creatives from a master template and three variations thereof, creative 270c being variation AI-C of the series AF-C 270a (master), AG-C 270b (variation), AI-C 270c (variation) and AJ-C 270d (variation), although it is technically data until displayed on a computer monitor, screen display or the like. The “hot spots” 274-278 in the respective creatives AF-C, AG-C, AI-C and AJ-C 270a-270d are based on locations in the data of the image link (the request, or content request).

The creative AI-C 270c, for example, with its “hot spots” filled with underlying links, as well as images, also stored in the imaging server (IS) 38, the images placed into the hot spots 274, 275, either with the creative (also called up from the imaging server (IS) 38 as detailed above) or separate therefrom, is sent to the proxy server 52, via the home server (HS) 30, at block 232. The images (e.g., sub images 284, 285) that are placed over the hot spots, serve as locations, which are activatable by a mouse click, or the like, that in turn activate links. The links are, for example, click links, planted in the hot spots, for example, hot spots 274, 275 of the creative (main images 281a, 281b or body of the creative) 270c in such a way that makes the image, or a portion thereof, clickable (activatable by a mouse click) (FIG. 9B). Each link (click link) includes an underlying URL for the proxy server 52 in a string with a unique identifier (UID) (e.g., md5), mailing identifier (MID), campaign identifier (CID), creative identifier (CCID), and position data (POS). An example string, for example, at POS=1 (the first position corresponding to the hot spot 274) may be as follows:

href=“http://p1proxyserver.com/ac/
Y2lkPTEwMTkxJmltPTEmdT01N2U4YzBiMGVmN
zAyYWI0ZWVlOTFhNjQ0Y2RjNTFmNSZtPTEwMDAwJmxpZD0yOD
Amc2k9MyZkbj1vdGhlciZj bD05JbVupPutGlG1-DLJLeaCrQ”>

and, for example, at POS=2 (the second position corresponding to the hot spot 275) may be as follows:

href=“http://p1proxyserver.com/ac/
Y2lkPTEwMTkxJmltPTImdT01N2U4YzBiMGVmN
zAyYWI0ZWVlOTFhNjQ0Y2RjNTFmNSZtPTEwMDAwJmxpZD0yOD
Amc2k9MyZkbj1vdGhlciZj bD05TetWeCXIF09gCJ2KpkB2wQ”>

The creative, for example creative AI-C 270c is rendered to the corresponding template AI 1302c as an image (represented by the box 151a of FIG. 4), at the single position (I1) 151, and is now an opened e-mail 290c (as detailed above), as sown in FIG. 10. FIG. 10 also shows other opened e-mails 290a, 290b and 290d, resulting from the rendering of templates AF 1302a, AG 1302b, and AJ 1302d, and corresponding creatives AF-C 270a, AG-C 270b, AJ-C 270d.

Staying in FIG. 10, the screen shot of this opened e-mail 290c, includes the rendered images 281a, 281b for the creative AI-C 270c (main image or body including locations for the hot spots, with images or sub images 284, 285 filling the hot spots) as would appear on the monitor of the user, as a viewable image. The other opened e-mail bodies 290a, 290b and 290d, include creatives 270a, 270b, and 270d on supporting templates 1302a, 1302b and 1302d, which were formed similarly to that of creative AI-C 270c of opened e-mail body 290c, but with more N=4 (270a, 270b) or fewer N=1 (270d) positions.

In FIG. 10, the exemplary e-mail 290c (as it appears on a recipient's computer or terminal screen upon the e-mail or other electronic communication being opened by the user) is based on a sent e-mail with two requests (content requests) (N=2), and therefore, the listing text returned from the requisite content server (CS) 34a-34n and stored in the listing and click caches, typically includes only two listings, as shown and described above. In the e-mail 280c, the images 281a, 281b placed into the section I1 151 of the template 150, for example, form the body of the e-mail (corresponding to the main image or body of the creative AI-C 270c), and include sub images 284, 285 over hot spots (corresponding to the positions, PPOS=1 and POS=2 of the creative 270c), covering the links. The images 281a, 281b and sub images 284, 285 may be a single static image covering, or separate static images, the static images of a fixed content formed prior to the e-mail being sent.

The images, for example, the sub images 284, 285 in the e-mail 290c, are typically selected and placed into the hot spots when the e-mail is opened and in accordance with the listings selected to be the links (in accordance with the processes detailed herein). These sub images 284, 285, may also include indicia, such as “Click now,” “Learn More,” or could be a line of text, typically underlined, such as in the broken line boxes of e-mails AG-C 290b and AI-C 290c. Under these sub images 284-287 are links, that when activated, typically by a mouse click on the area of the respective sub image 284-287 of the e-mails 290a-290d in FIG. 10, ultimately provide the browser of the user 41a with a redirect URL, directing the browser to a target web site (or web page). This web site (or web page) is from the listing that resulted in the image that supported the clicked or activated link.

The aforementioned links (which underlie the sub images 284-287 (in FIG. 10) to cover the hot spots 274-277 for POS=1, POS=2, POS=3 and POS=4, respectively, in each of the creatives of FIGS. 9A and 9B) include underlying strings. As detailed above, each string typically includes a URL for the proxy server 52 that will map to the home server (HS) 30, as indicated by “ac” detailed above. The data, for example, includes a unique identifier (UID), a mailing identifier (MID), a campaign identifier (CID), a creative identifier (CCID), and position data (POS=1 to n, where n=N, the total number of positions or click links), embedded in code, data or the like therein, with the unique identifier (UID), campaign identifier (CID) and mailing identifier (MID) being used to define a key (as detailed above). Example strings, for the each of the two positions (POS=1 and POS=2) are from the click links, listed above.

Activating the link, for example, by a mouse click in the area defined by the sub images 284-287, directs the user's browser to the home server (HS) 30, through the proxy server 52 (as the proxy server 52 is mapped to the home server (HS) 30. From the data in the string, a click cache 43d may be accessed. By accessing the click cache 43d, the browser receives a redirect URL for a web site (or web page) (that is targeted) corresponding to the image from the cached listing, as detailed below. The user's browser is ultimately directed to a target web site (target web page) corresponding to the redirect URL. The process for redirection to the target URL, resulting from opening an e-mail and clicking (activating) the requisite link, is described with reference to FIG. 11. This redirection is a click through, as the once clicking on or activating the link underlying the sub image 284, 285, the user (recipient), for example, user 41a, will see the web page of the target web site on his monitor, screen, or the like.

FIG. 11 shows a flow diagram of a process or method for redirecting the browsing application of (associated with) a user (via his computer) to the URL of a target web site (or web page). This process may be a third phase of the larger process, where the user reaches the web site (or web page) (target web site or target web page) of the party associated with the listing that became the of the time-relevant content of the creative, for example, creative AI-C 270c and corresponding e-mail 290c.

Initially, the user, now having received the rendered images in the e-mail, for example, now-opened e-mail 290c (creative, main image or body and sub images for the hot spots of the creative main image supported by the template), will “click” on an image, i.e., the area of the sub image 284, 285, which covers the link, as shown in FIG. 10, to which reference is now also made. Each link, as discussed above, is associated with a string, that includes the URL of the proxy server 52, that is mapped to the home server (HS) 30, with the unique identifier (UID), mailing identifier (MID), campaign identifier (CID), creative identifier (CCID) and position data (POS=1 to n, where n=N, the total number of positions or click links), embedded therein.

At block 302, as a result of the user mouse clicking on the selected sub image and link, the home server (HS) 30 receives a unique identifier, campaign identifier, mailing identifier and position data (for the image location), typically in the above-described string. This receipt is through the proxy server 52, that initially receives the aforementioned data, and passes it through to the home server (HS) 30, as it is mapped to the home server (HS) 30 (by “ac” in the string, as detailed above. Accordingly, upon the activation or click of the requisite link, for example, the link under sub image 284 (corresponding to hot spot 274 and POS=1) being clicked or activated, the proxy server 52 opens a connection or “pipe” to the home server (HS) 30, through which the sent unique identifier, campaign identifier, mailing identifier and position data (for the image location), is passed through.

The home server (HS) 30 then creates a key from the unique identifier (UID), the mailing identifier (MID), and the campaign identifier (CID), and locates the matching key in the key cache 43a. With the matching key located, the corresponding key in the click cache 43d is located. The click cache 43d is queried for position data matching the position data of the string (of the link), in order to obtain a redirect URL for the particular position data, at block 304. It is then determined if the redirect URL is in the click cache 43d, at block 306.

The redirect URL is a URL for the web site corresponding to the clicked text portion on the rendered e-mail, as programmed into the listed text in the click cache 43d. This URL is typically for a target web site or web page (content) on (or hosted by), for example, a third party server (TPS) 42a-42n.

If the redirect URL is not in the click cache 43d, the process moves to block 210, as shown by the broken line arrow of FIG. 5. The process continues through block 217 of FIG. 5, as shown by the broken line arrow, collectively, block 308, and returns to block 302.

However, if the redirect URL is in the click cache 43d (with the matching position data), the home server (HS) 30 sends the web browser of the user 40 the redirect URL at block 310. The user's web browser receives this redirect URL, and automatically accesses the web page (typically, a target web page) corresponding to the redirect URL.

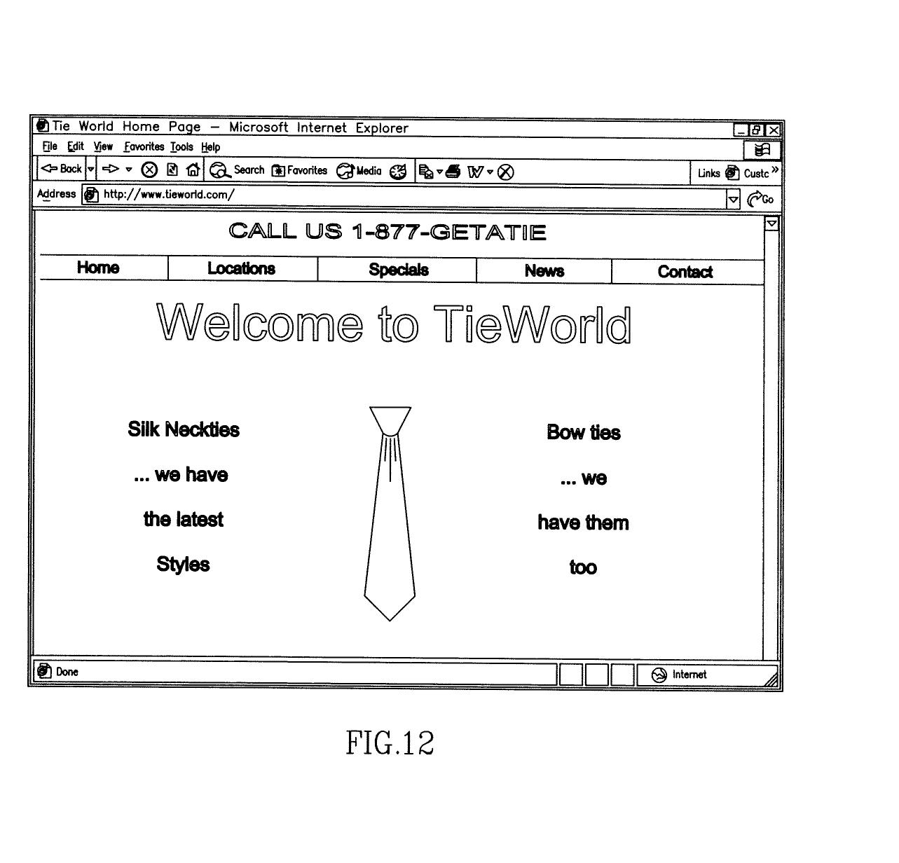

For example, the redirect URL (from KEY 1, position data POS=1 in the example click cache 43d of FIG. 8) may be “www.tieworld.com.” In this case, the user's web browser would be directed to www.tieworld.com, whereby the web page, obtained at the address www.tieworld.com, shown in FIG. 12, would appear on the monitor of the computer 41b of the user 41a. The server that hosts the web site associated with www.tieworld.com.com may be any one or more of the third party servers (TPS) 42a-42n.

The click cache 43d is may be programmed to expire in a predetermined time period. This time may be, for example, approximately two hours, whereby it will need to be refreshed, restarting the above described processes.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other non-transient source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A computer-implemented method for providing content to an electronic communication over a communications network comprising:
a computer system:
a) receiving an identifier corresponding to an e-mail address of an intended recipient of an electronic communication;
b) assigning a classification to the identifier, each time an identifier is received;
c) obtaining i) data for a content-supporting graphic, ii) template data for at least one template for supporting the content-supporting graphic, and iii) data for content requests that automatically activate when the electronic communication is activated, for the electronic communication to be sent by a sender entity to the intended recipient computer over the communications network, the content-supporting graphic data based on the assigned classification of the received identifier; and,
d) providing the data for the content-supporting graphic for the electronic communication, the template data, and the content requests data, to a sender entity, the sender entity for configuring i) the content-supporting data into the at least one template of the template data, and ii) the content requests data into the electronic communication, and, for the for sending the electronic communication to the intended recipient computer.

2. The method of claim 1, wherein the sender entity sends the electronic communication to the intended recipient computer, over the communications network.

3. The method of claim 1, wherein the identifier is encrypted.

4. The method of claim 1, wherein the content-supporting graphic includes a creative.

5. The method of claim 1, wherein the communications network includes the Internet.

6. The method of claim 2, wherein the sender entity is separate from the entity associated with the of the computer system.
